(19) United States
(12) Patent Application Publication
(10) Pub. No.: US 2015/0242395 A1
(43) Pub. Date: Aug. 27, 2015

(54) SYSTEMS AND METHODS FOR EQUIPMENT SHARING

(71) Applicant: Transcriptic, Inc., Menlo Park, CA (US)

(72) Inventor: Max Hodak, Woodside, CA (US)

(21) Appl. No.: 14/629,371

(22) Filed: Feb. 23, 2015

Related U.S. Application Data
(60) Provisional application No. 61/943,878, filed on Feb. 24, 2014.

(51) Int. Cl. G06F 17/28

(52) U.S. Cl. CPC G06F 17/28

(57) ABSTRACT

A generic language is provided that can be translated to fit a configuration of a specific site to enable equipment sharing of a site provider with a user. A user can write a program using the generic language to describe an experiment. A central system can determine sites that are available to perform the experiment. Upon site selection and sample availability, a translation system translates the program into a set of operations to be performed based on a site-specific configuration. A schedule system may schedule the operations to be performed on the equipment according to constraints provided by the program, site operator, and/or equipment. A task manager may implement the operations as scheduled. A report describing operations performed and results obtained can be generated by the selected site upon completion of the set of operations. Products, samples and/or reports can then be returned to the user.

### CROSS-REFERENCE TO RELATED APPLICATION

This application is a non-provisional application and claims the benefit of priority of U.S. Provisional Application No. 61/943,878, filed on Feb. 24, 2014, titled “Apparatus and Method for Equipment Sharing,” which is herein incorporated by reference in its entirety for all purposes.

### BACKGROUND

Aspects of the disclosure relate to automation of equipment. In particular, aspects of the disclosure relate to systems, methods, apparatuses, and computer-readable media for equipment sharing to perform experiments across sites with diverse configurations and setup requirements.

The scientific method allows an experiment to be designed to answer a question. When the experiment is performed, the experiment can be viewed to answer the question or determine lack of sufficient information for a conclusion. Reporting of this experimental information can be through scientific papers, journals, articles or postings on websites. Using the experimental information, others can attempt to answer the question, using a same, similar or different process. This repeatability allows people to trust an answer found through an experiment.

Unfortunately, even if the experiment disclosure is sufficient for repeatability, access to equipment can impede the ability of others to repeat the experiment. The equipment can be specialized, expensive to buy, expensive to maintain, dangerous, difficult to operate or can have other attributes that make the equipment difficult to obtain or use.

Many branches of science and/or engineering also have an associated language and know-how. This language and know-how can include assumptions about knowledge and performance of experiments. These knowledge and performance assumptions can be influenced by a context of the experiment. For example, an experiment in industry may have a different set of assumptions than an experiment in academia.

### BRIEF SUMMARY

Techniques described and suggested herein include systems and methods for sharing equipment through use of a generic language that can be translated to fit a configuration of a specific site. A user can write a program using the generic language to describe an experiment. The user can submit the program to a central system that can determine sites that are available to perform the experiment as described by the program. Upon site selection and sample availability, the central system can send the program to a translation system that translates the program into a set of operations to be performed, based on a site-specific configuration. The translation system can then provide the set of operations to a scheduling system that schedules the operations to be performed on the equipment according to constraints provided by the program, site operator and/or equipment. The scheduling system can then provide the schedule of operations to a task manager that implements the operations as scheduled. The task manager can then create a report describing operations performed and results obtained. Products, samples and/or reports can then be returned to the user.

The generic language can encapsulate the functionality of the physical equipment of a site, while inferring site-specific details. The generic language can be used to describe steps of a process without delving into automation specifics. A site-specific configuration can describe variables, equipment states, transfer procedures, setup procedures, clean-up procedures and other procedures that can be used to translate steps from the generic language into operations performed in the laboratory. In some embodiments, a step of a process can be separated into one or more operations of equipment at a site. In other embodiments, multiple steps can be combined and executed by a set of one or more operations.

The generic language can also provide a complete description of an experiment, allowing repetition across multiple sites with varying configurations. A high-level language can be used to describe experiments. The high-level language description can then be broken down into individual operations performed by equipment based at least in part on a site-specific configuration describing functionality of equipment available at a site. A resulting set of operations can then be used at a site to perform the experiment. The operations can include equipment instructions, human instructions and/or a hybrid of both.

Some embodiments may include a computing system that can coordinate with, communicate with, and/or direct site equipment. At least a portion of the computing system may be placed on the premises of a laboratory system. In certain embodiments, the computing system may include a translation system, scheduler, and/or task manager. The computing system can include hardware and/or software interfaces that communicate with on-premises equipment. Using the hardware and/or software interfaces, the computing system can coordinate actions of the on-premises equipment to run one or more experiments in parallel. In some embodiments, the computing system can include manual interfaces that allow a technician to perform manual tasks and alert the computing system when the manual tasks are complete, such that automation can resume.

Certain embodiments can include a scheduling system that may allow multiple users to share use of the equipment such that experiments can be run in parallel. The scheduling system can use batching techniques, interleaving of operations and other parallelization techniques to increase efficiency and utilization of machines based on the operations derived from the high level language description of the experiements. The scheduling system can search for solutions that parallelize the operations while meeting constraints of the experiments, machines, and site requirements. In some embodiments, the search for a parallelized solution can include creating a tree structure to step through potential solutions and eliminate branches that do not meet constraints.

Various embodiments can provide a computer-implemented method of sharing equipment through use of a generic language that can be translated to fit a configuration of a specific site. In some embodiments, the method includes receiving automation instructions from a requesting party. The method can include determining a site configuration of an automated laboratory in which to execute the instructions. The method can also include generating a transcript executable by the automated laboratory, based at least in part on the automation instructions and the site configuration. In some embodiments, the method includes scheduling execution of the transcript on automated laboratory equipment at the automated laboratory. In certain embodiments, the method may also include receiving results based at least in part on the execution of the transcript on the automated laboratory equipment.

In certain embodiments, the automation instructions may include a program written in a generic language where the program describes an experiment. In certain embodiments, generating the transcript may include translating the program into a set of operations to be performed for the experiment at the automated laboratory. In certain embodiments, generating the transcript may include translating the automation instructions in a generic language to the transcript in site-specific instructions. In certain embodiments, the method may also include identifying a number of sites that are capable of performing the experiment and receiving a selection of a site from the multiple sites and arranging transfer of one or more samples to the selected site, where the generated transcript includes a set of operations to be performed at the selected site.

In certain embodiments, the method may include receiving additional automation instructions from another requesting party. The method may also include determining another site configuration of another automated laboratory in which to execute the additional instructions. In some embodiments, the method includes generating another transcript executable by the other automated laboratory, based at least in part on the additional instructions and the other site configuration. The method may also include scheduling execution of the other transcript on a set of laboratory equipment at the other automated laboratory. In certain embodiments, the transcript may include a set of operations to be executed at the automated laboratory based on the site configuration.

In certain embodiments, the method may include receiving additional automation instructions from another requesting party. The method may also include determining to execute the additional instructions at the automated laboratory. In some embodiments, the method may include generating another transcript executable by the automated laboratory, based at least in part on the additional instructions and the site configuration at the automated laboratory. The method may further include scheduling execution of the other transcript on a set of automated laboratory equipment at the automated laboratory.

Various embodiments provide a computer-implemented method of generating multiple transcripts executable by multiple laboratory systems. In some embodiments, the method includes receiving laboratory automation instructions in a first language from a requesting party. The method can include determining a first target laboratory system in which to execute the instructions. The method can also include generating a first transcript executable by the first target laboratory system based at least in part on the first language. In some embodiments, the method includes determining a second target laboratory system in which to execute the instructions. In certain embodiments, the method also includes generating a second transcript executable by the second target laboratory system, based at least in part on the first language.

In certain embodiments, the second target laboratory system is a manual labor laboratory system where the second transcript is a set of natural language instructions. In certain embodiments, the first transcript is generated further based upon a site-specific configuration for the first target laboratory system. In certain embodiments, the first language is a high-level language. In certain embodiments, the first target laboratory system is an automated laboratory system. In certain embodiments, the method further includes generating an additional transcript executable by the first target laboratory system based at least in part on the first language. In some embodiments, the first target laboratory system is a semi-automated system that can perform both automated and manual tasks.

Various embodiments provide a computer-implemented method of generating a transcript executable by an automated laboratory. In some embodiments, the method can include receiving automation instructions from a requesting party in a first language. The method may include determining a number of sites compatible with the automation instructions. In some embodiments, the method includes receiving a selection of a site from the number of sites in which to execute the instructions where the site is associated with an automated laboratory. In certain embodiments, the method includes retrieving a site configuration of the site. The method may also include generating a transcript executable by the automated laboratory in a second language, based at least in part on the automation instructions and the site configuration.

In certain embodiments, the method may further include generating another transcript executable by the automated laboratory based at least in part on additional instructions in a third language and the site configuration. The method may also include scheduling implementation of the transcript and the other transcript using the automated laboratory. In certain embodiments, the method may further include communicating with automation equipment based at least in part on the automation instructions to accomplish the transcript. The method may include reporting results of the transcript to the requesting party.

In certain embodiments, generating the transcript may include translating the automation instructions to the transcript that includes a set of site-specific operations to be executed on the site. In certain embodiments, the method may further include determining an order, a timing, and parallelization of operations from the transcript based on one or more constraints. The method may include executing the operations from the transcript based on the determined order, timing, and parallelization of operations. In certain embodiments, the method may further include upon determining the number of sites compatible with the automation instructions, presenting the number of sites compatible with the automation instructions and cost information associated with each of the number of sites. In certain embodiments, the method includes determining one or more solutions that meet one or more constraints associated with the automation instructions. In some embodiments, the one or more solutions are associated with one or more sites. In some embodiments, generating the transcript includes translating the automation instructions into a set of operations that satisfy the site configuration and the one or more constraints associated with the automation instructions.

Various embodiments can provide a computer-implemented method that can enable multiple users to share use of equipment at a same laboratory system. In some embodiments, the method can include receiving first laboratory automation instructions in a first language from a first requesting party. The method can include determining a first target laboratory system in which to execute the first instructions. The method can include receiving second laboratory automation instructions in a second language from a second requesting party. In some embodiments, the second language can be the same or similar to the first language. In certain embodiments, the second language may be different from the first language.

The method can include determining a second target laboratory system in which to execute the second instructions. In certain embodiments, the second target laboratory system can be the same as the first target laboratory system. In some embodiments, the first target laboratory system and the second target laboratory system may be related such that the systems have overlapping facilities, services, and/or equipment.

The method can include generating a first transcript executable by the first target laboratory system, based at least in part on the first language. The method can also include generating a second transcript executable by the first target laboratory system, based at least in part on the second language. The method can schedule implementation of the first transcript and the second transcript, using the first target laboratory system. The method can execute the first transcript and the second transcript using the first target laboratory system. In certain embodiments, the method may further include determining that an operation of the first transcript has terminated earlier than scheduled and rescheduling implementation of the first transcript and the second transcript, using the first target laboratory system.

Various embodiments may provide a computer-implemented method of communicating with automation equipment based on automation instructions. In some embodiments, the method can include receiving an automation transcript from a requesting party in a first language compatible with a site configuration of a site. The transcript may have been generated from a second language based at least in part on the site configuration. In certain embodiments, the method can include communicating with automation equipment based at least in part on the automation instructions to accomplish the automation transcript. Some embodiments may report results of the automation transcript to the requesting party.

### BRIEF DESCRIPTION OF THE DRAWINGS

FIG. 1 depicts a block diagram of an embodiment of a protocol translation service.

FIG. 2 depicts a flowchart of an embodiment of a process for protocol sharing.

FIG. 3 depicts a flowchart of an embodiment of a process that uses equipment sharing.

FIG. 4 depicts a block diagram of an embodiment of a management system configured for equipment sharing.

FIG. 5 illustrates a flowchart of an embodiment of a process for equipment sharing.

FIG. 6 illustrates a chart of an example of code configured to extract a bacteria culture.

FIG. 7 illustrates a chart of an example of code from FIG. 6 that is translated into a human-readable format.

FIG. 8 illustrates a flowchart of an embodiment of a process for generating site-specific code for equipment sharing.

FIG. 9 depicts a block diagram of an embodiment of an equipment sharing service.

FIG. 10 depicts a block diagram of an embodiment of a management system configured for physical device sharing.

FIG. 11 illustrates a flowchart of an embodiment of an example process for scheduling equipment sharing.

FIG. 12 illustrates a flowchart of an embodiment of a process for repeating experiments using equipment sharing.

FIG. 13 illustrates a flowchart of an embodiment of a process for dynamic scheduling of shared equipment.

FIG. 14 illustrates a flowchart of an embodiment of a process for using shared equipment.

FIG. 15 depicts a block diagram of an embodiment of a computer system, in accordance with certain embodiments of the present invention.

FIG. 16 depicts a block diagram of an embodiment of a special-purpose computer system, in accordance with certain embodiments of the present disclosure.

In the figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment of the disclosure.

It should be understood that various changes may be made in the function and arrangement of elements without departing from the spirit and scope of the disclosure as set forth in the appended claims.

Techniques described and suggested herein include systems and methods for sharing equipment through use of a generic language that can be translated to fit a configuration of a specific site. In one embodiment, a user can write a program using the generic language to describe an experiment, such as plasmid isolation using alkaline lysis solutions, centrifugation and mixing. The user can submit the program to a central system and request a site that can be used to perform the experiment as described by the program. The central system can identify one or more sites that are capable of performing the experiment. The user can select one or more sites and arrange transfer of samples to the sites, if needed. The central system can send the program to a translation system that translates the program into a set of operations to be performed at the specific site. These operations can include preparation of standard solutions, movement of robotics, calibration of equipment or other procedures necessary to carry out the experiment. The translation system can then provide the set of operations to a scheduling system. The scheduling system can then schedule the operations to be performed on the equipment while obeying constraints provided by the program and/or equipment. The scheduling system can then provide the schedule of operations to a task manager that implements the operations as scheduled. These schedules of operations can include initialization operations (e.g., the creation of standards or calibration of sensors), site-specific operations (e.g., open sample storage door, move robotic arm to a specified position, store equipment reading), experiment-influenced operations (mix for two minutes by repeatedly inverting robot wrist by 180 degrees, mix until phosphorescent reading reaches a specified value), clean-up operations among others (e.g., dispose of tip, dispose of solution, wash tray), reporting operations (send summary list of operations, timing and values obtained), etc.

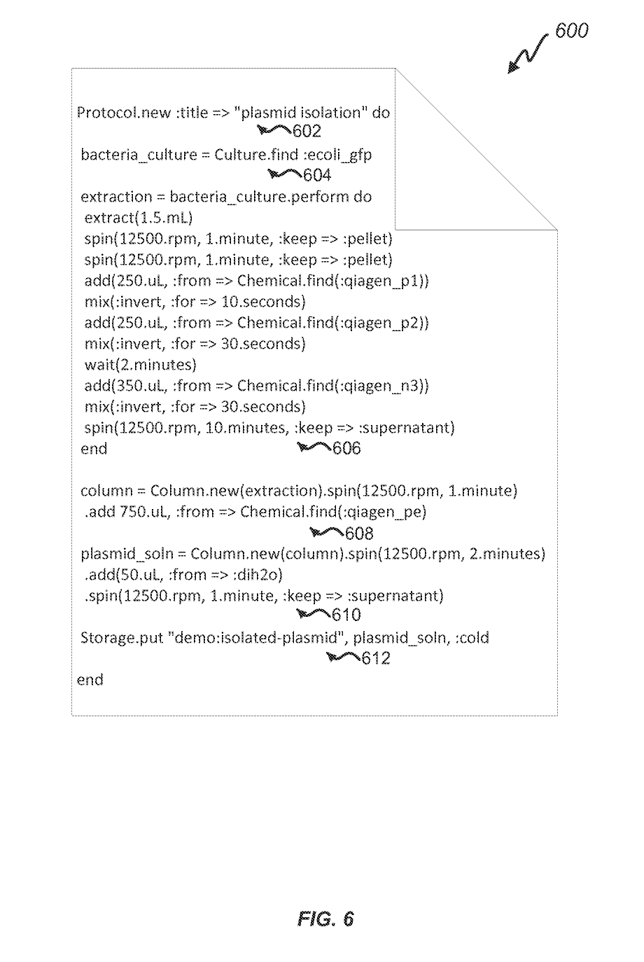

For example, a user can create a program that describes plasmid isolation using alkaline lysis solutions, centrifugation and mixing (see e.g., FIG. 6). The user can describe the procedure in programming terms of selecting a sample, adding alkaline lysis solutions, spinning for amounts of time and then storing a resulting supernatant and also include any constraints (e.g., timing, temperature, etc.). The user can submit the program to a central server that determines that a university has the capability of selecting a sample, adding alkaline lysis solutions, spinning for amounts of time and then storing a resulting supernatant. The user can submit payment, if needed, and reserve use of the university equipment. The user can deliver a sample to the university for the experiment. Upon receipt, the university notifies the central server that the sample is ready. The central server can then send the program to a translation system that uses a site-specific configuration describing the university laboratory to determine a set of operations that must be performed to accomplish the program (e.g., robotic movements, creation of standard solutions, calibration, etc.). The translation system can translate the program from high level commands (e.g., find the e coli sample) to specific instructions (e.g., retrieve location of sample, move robotic arm to x, y, z above sample, rotate wrist to horizontal, move arm to to x, y-20, z, close hand to 20 distance, move arm to x, y, z above sample, rotate arm to a, b, c above centrifuge, etc.) The translation system can send the set of operations to a scheduling system that determines when the equipment can perform the requested operations while satisfying any site constraints or program constraints. The scheduling system can determine that the robotic arm, centrifuge and dispensing arm are free from 10am to 10:30am and schedule the operations to complete from 10am to 10:10am. With the scheduling complete, the scheduler can transmit the schedule of operations to a task manager that implements the schedule and performs the scheduled operations from 10am to 10:10am and reports completion times of operations and any requested observations. The university can request receipt of the payment for the automation services rendered. Operators of the central server can take a portion of the payment as a fee for rendering the sharing services.

Using this method of sharing laboratory equipment can allow equipment owners to more fully utilize equipment, while it can also allow users access to equipment that may not be possible for the users to purchase or have the skills to operate. Sharing equipment as described can reduce the cost of ownership for the equipment and/or provide additional revenue sources.

The generic language can encapulate the functionality of the physical equipment of a site, while inferring site-specific details such as instrument tip changes and instrument flushes. A high-level language can be used to describe experiments. The high-level language description can then be broken down into individual operations performed by equipment, based at least in part on a site-specific configuration describing functionality of equipment available at a site. A resulting set of operations can then be used at a site to perform the experiment. The operations can include equipment instructions, human instructions and/or a hybrid of both.

For example, a high-level language description (see e.g., FIG. 6) can be customized to operate at multiple different laboratories. In a first laboratory, a system can be fully automated. Instructions for computing resources and equipment can be generated, based on a site-specific configuration for the first laboratory and the high-level language description. A task management system can coordinate and/or control the automation systems. Instructions can be executed by a task manager that causes robotic arms to transfer samples between laboratory equipment and causes readings to be taken by the equipment and stored for later reporting. In a second laboratory, a system can be completely manual. A set of human-readable instructions can be generated for the second laboratory, based on the high-level language description and the site-specific configuration for the second laboratory. Instructions can use terminology that refers to specific equipment in the laboratory (such as “the east refrigerator”). In a third laboratory, two sets of instructions can be created to utilize semi-automated systems. A human can be requested to perform tasks, such as loading a machine with a sample and then pressing a “go” button that causes the machine to execute a set of instructions, based on the high-level language description.

In some embodiments, an existing high-level language can be used with extensions (e.g., a library) that represent steps in processes. For example, a Java™ or C++™ program can be written to use logical constructs within the language, while using library calls (e.g., data constructs and/or method calls to a library) to represent steps of the experiment. By combining a high-level language with a library, a user can create an experiment using familiar (and potentially complex) logic and/or control while interfacing with equipment through the library interface.

The generic language can also provide a complete description of an experiment, allowing repetition across multiple sites with varying configurations. The generic language can be used to describe steps of a process without delving into automation specifics. A site-specific configuration can describe variables, equipment states, transfer procedures, setup procedures, clean-up procedures and other procedures that can be used to translate steps from the generic language into operations performed in the laboratory. In some embodiments, a step of a process can be separated into one or more operations of equipment at a site. In other embodiments, multiple steps can be combined and executed by a set of one or more operations. However, the process (sometimes called a protocol) can be complete (i.e., allowing the process to be repeatable from lab to lab). By using a generic language to describe the process, assumptions and/or common knowledge can be avoided while inferring automation operations to site operations. This description of an experiment can allow a procedure to be fully specified and repeatable across multiple sites.

As used herein, an experiment means a set of instructions for using equipment and consumables tailored to a specific site for application in a consistent manner. An experiment can include laboratory processes in chemical and biological fields to determine an outcome of a postulate. An experiment can include machine shop instructions and tolerances to produce and/or assemble products. While the description may focus on scientific processes and/or automation, it should be recognized that other applications for consistent application of instructions are anticipated, such as at a machine shop.

A scheduling system can allow multiple users to share use of the equipment such that experiments can be run in parallel. The scheduling system can use batching techniques (e.g., grouping samples on a single carrier that share reagent deposits and/or temperature constraints), interleaving of operations (e.g., performing an operation on a second sample on a machine while a first sample is mixing before returning to the machine) and other parallelization techniques to increase efficiency and utilization of machines.

In some embodiments, the scheduling system can optimize use of equipment such that experiments from a plurality of users can be executed in parallel. The scheduling system can find a solution that allows multiple constraints of multiple users to be satisfied. For example, a first experiment can include a waiting period of 10 minutes between sample spins on a centrifuge. During that 10 minutes, a second experiment sample can move from a phosphorescence sensor to the centrifuge and spin for 5 minutes before returning to a decanting machine. In another example, two experiments require 5 minute spins in a centrifuge. A first experiment requires at least a 2 minute wait time and a second experiment requires no more than a 3 minute wait time between spins. Samples from the first experiment and second experiment can be loaded in the centrifuge and spun together. Using optimizations, such as these and others, multiple experiments can be run in parallel and machine utilization can be increased.

A computing system can be placed on premises that coordinates with, communicates with and/or directs site equipment. The computing system can include a translation system, scheduler and/or task manager. The computing system can include hardware and/or software interfaces that communicate with on-premises equipment. Using the hardware and/or software interfaces, the computing system can coordinate actions of the on-premises equipment to run one or more experiments in parallel. In some embodiments, the computing system can include dual interfaces that allow a technician to perform manual tasks and alert the computing system when the manual tasks are complete, such that automation can resume.

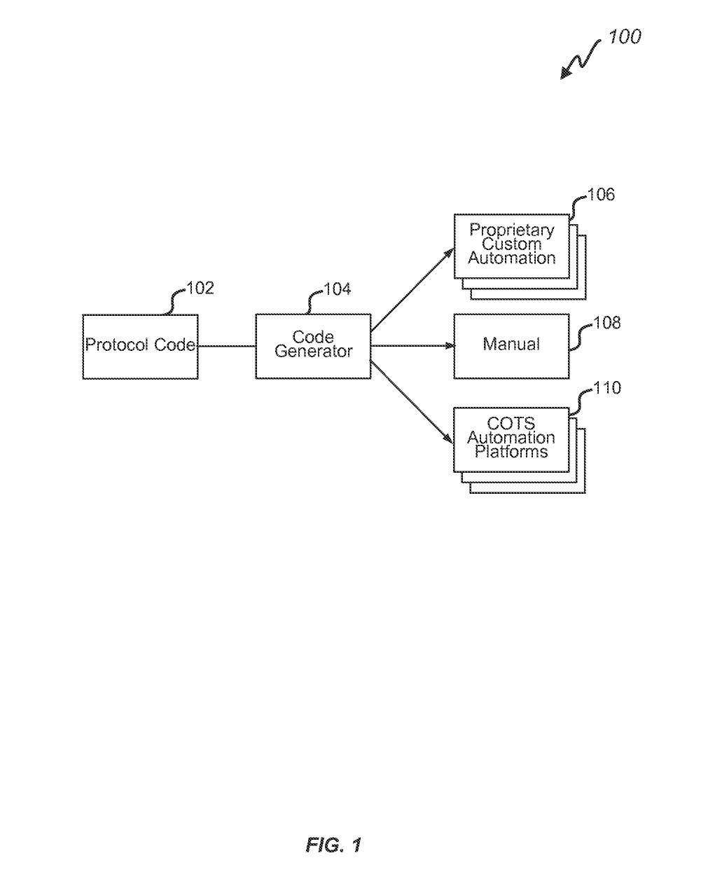

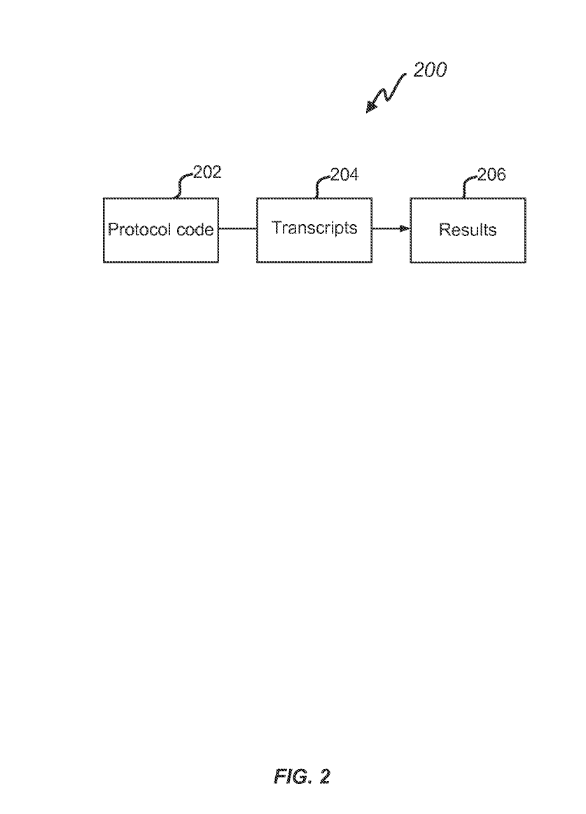

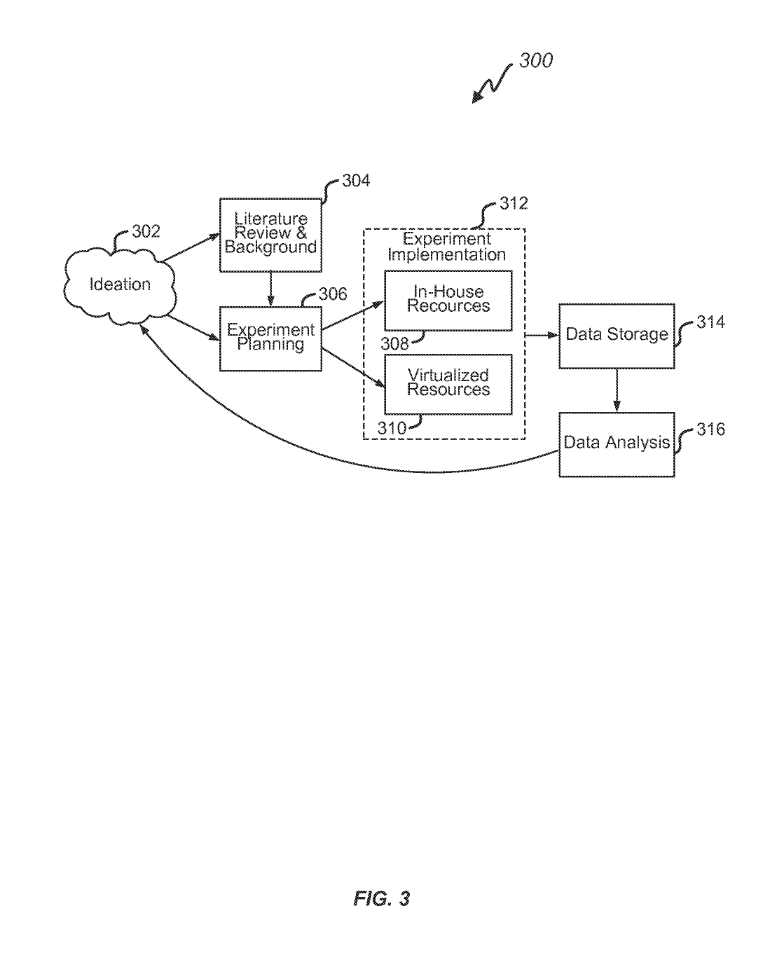

In FIGS. 1 to 3, the use of an equipment-sharing system is shown in a larger research context. The block diagram of FIG. 1 shows a high level view of how protocol code written in a generic language is applied to differing laboratory systems. The flowchart of FIG. 2 shows a high level view of how protocol code is applied to achieve results. The flowchart of FIG. 3 shows how the equipment sharing system can be integrated with traditional research processes.

Turning now to FIG. 1, a block diagram of an embodiment of protocol translation service 100 is shown. A user composes a protocol using a high-level language to create protocol code 102. Protocol code 102 can be translated and transmitted by code generator 104 (also referred to as compiler) to be executed on platforms 106, 108 and 110 at a specific site (e.g., by a dispatcher). Translations of protocol code 102 can be directed to proprietary custom automation 106, manual operations 108, and commercial-off-the-shelf automation platforms 110.

Protocol code 102 can be composed in a generic language describing machine operations. Protocol code 102 can specify steps of a process and constraints. In some embodiments, the steps describe actions as operations on materials (e.g., samples, products, etc.). The actions can specify attributes of the actions (e.g., spin at 12,400 rpm for 1 minute, mix by inversion for 30 seconds, store in cool storage until next use). The actions can be given with enough specificity such that an experiment is fully specified (i.e., can be repeated across multiple sites) without including implementation details of each site (e.g., robotic movement commands).

Not only can using the generic language to describe operations allow for cross-site implementation, it can also ensure that a protocol is fully specified. For example, replication of experiments can depend on fully specified protocols. However, in practice, it can be difficult to determine when a protocol is fully specified, as protocols can be simply a text description. Using protocol code 102 enables checking and verification of protocols. In some embodiments, a protocol can be verified to include sufficient description for each action (e.g., required attributes for each action). This verification can allow a protocol to be analyzed for missing information. For example, an action can include both required and optional parameters. If the required parameters are missing, the action may not be fully specified.

Constraints can also be included in protocol code 102. The constraints can describe additional information, such as variables to be controlled. In some embodiments, these constraints are not obvious, but may have an effect on an outcome of an experiment. For example, a sample may need to remain in a specific temperature range. When a reagent is added to the sample, the sample may need to be processed within a certain amount of time or the reagent effect may be limited. By specifying constraints, additional variables can be controlled.

In some embodiments, the generic language can be an independent language or extensions to an existing high-level language. The generic language can be an independent language, such as Autoprotocol™ by Transcriptic, Inc. of Menlo Park, Calif. The independent language can be interpreted or compiled. In some embodiments, the generic language is represented as data. The generic language can also be language extensions to an existing language. For example, the generic language can be Ruby™ syntax with Autoprotocol™ library extensions. Other languages can include C™, Java™, Objective-C™, C++™, C#™, PHP™, Basic™, Python™, Transact-SQL™, JavaScript™, Visual Basic .NET™, Perl™, Ruby™, Pascal™, Lisp™, MATLAB™, Delphi™ and PL/SQL™. In some embodiments, the existing language can be used for program logic and/or program control while the language extensions provide automation functions.

Code generator 104 can use site-specific configuration information to determine proper translation of protocol code 102 to operations executable on platforms 106, 108 and 110. In some embodiments, the code generator can use the site-specific configuration to translate steps of the protocol code 102 into site operations on platforms 106, 108 and 110 at a site. After determining operations to perform at the site, code generator 104 can search for solutions that perform the operations while satisfying constraints.

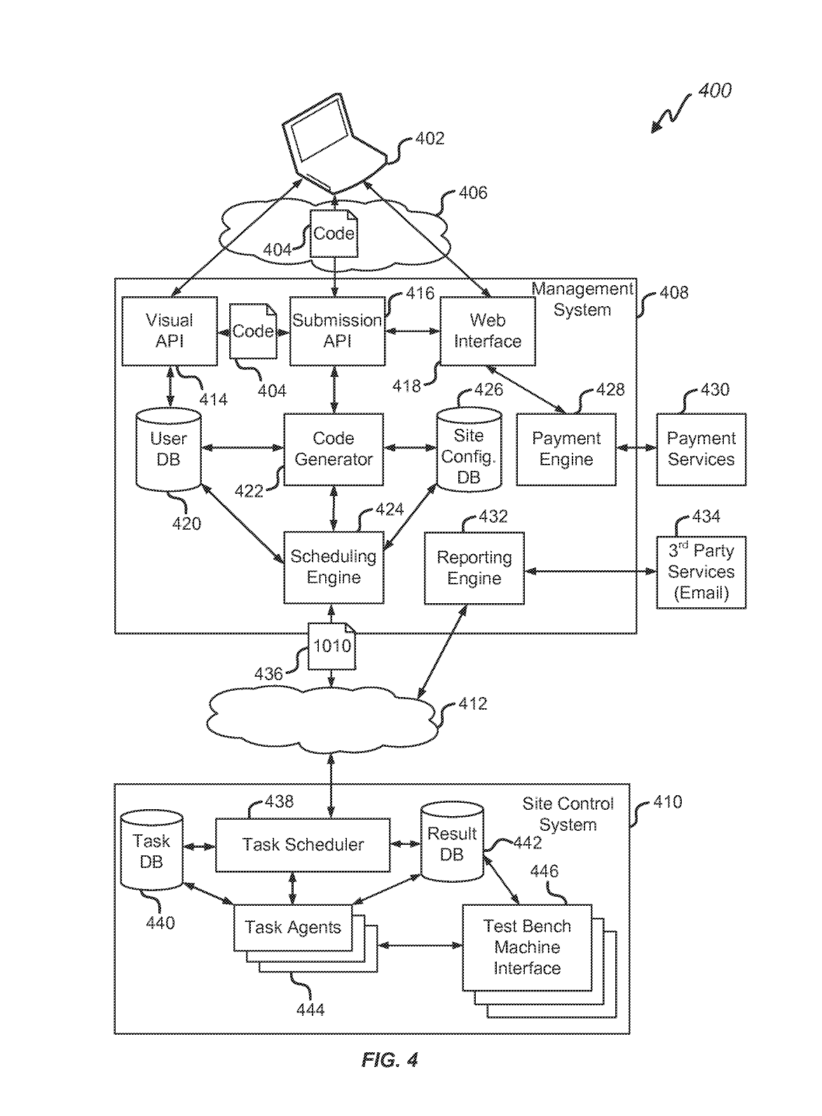

In one embodiment, code generator 104 uses a tree data structure comprising warps. The warps can be a node of the tree, with each warp including an operation and zero or more children upon which it depends. While constructing the tree, constraints can be tested to ensure that a branch satisfies the given constraints. When the tree is finished, a traversal of the tree can provide an order of operations that satisfies at least some constraints (other constraints can be real-time constraints, such as limitations to movement and temperature). In some embodiments, a dispatcher (such as scheduling engine 424 or task scheduler 438 described in FIG. 4) can schedule more than one experiment in parallel with an order of operations that specifies operations from more than one protocol code.

The site-specific information can provide instructions on translation of protocol code 102 to site operations. The site-specific configuration can include automation information (e.g., robotic movements required to acquire and move a sample through a process), machine commands (e.g., data and/or messages to be transmitted to machinery to cause readings and/or actions), setup information (e.g., automation, commands and/or acquiring of chemicals to make reagents and/or standard solutions and/or other calibration requirements), logging information (e.g., information to store about completion of operations and/or readings from equipment) and other information that can be inferred from protocol code 102.

Code generator 104 can interoperate with, coordinate with, communicate with and/or direct various platforms 106, 108 and 110. A dispatcher (not shown here) that is part of a platform 106, 108, or 110 can operate platform equipment as needed. In one embodiment, a dispatcher receives a driver from a repository. The driver can provide functionality that enables communication with one or more pieces of equipment. In some embodiments, the driver enables direct operation of the equipment, such as over a hardware interface. In other embodiments, the driver enables indirect operation of the equipment, such as loading a set of instructions, requesting performance of the instructions and awaiting a completion notification. In one embodiment, the driver enables automation operation of the equipment; for example, a high-level command is given and the equipment determines how to perform the requested command (e.g., the equipment is requested to take a visible light spectrum transmittance reading of a sample loaded in bay 1).

Platforms can include proprietary custom automation 106, manual operations 108 and commercial-off-the-shelf automation platforms 110. A proprietary custom automation system 106 can include systems and equipment constructed and/or integrated by a client. Proprietary custom automation system 106 can include some off-the-shelf components that are integrated on site. A manual operation 108 can include systems and equipment that are manually operated and/or a hybrid of manual and automation. Commercial-off-the-shelf automation platform 110 can include commercial systems that are integrated with a site for automation. In some embodiments, the commercial-off-the-shelf systems include application programming interfaces (APIs) that are used to control the systems.

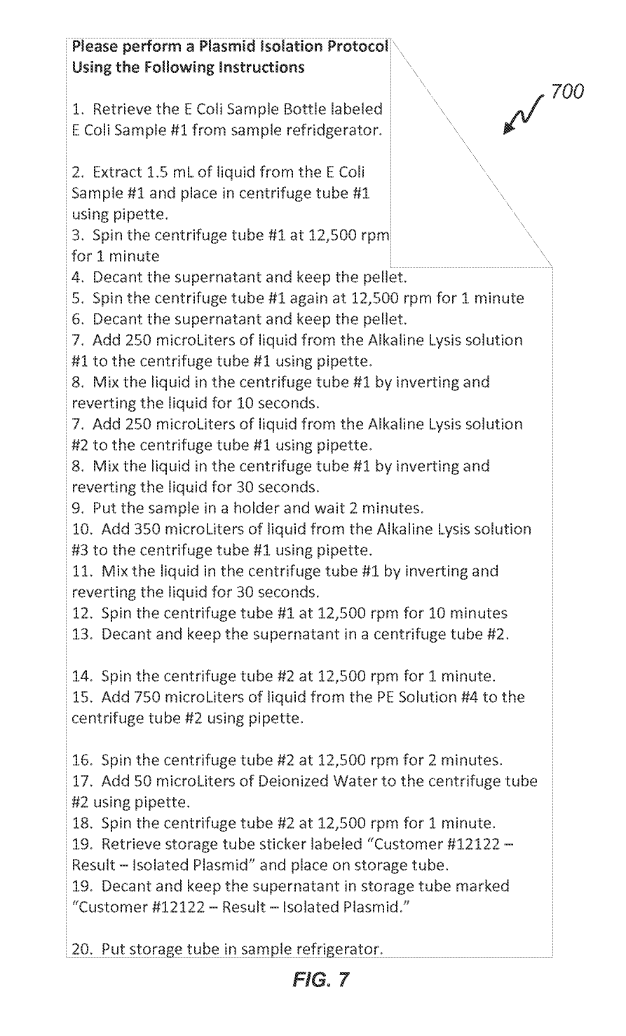

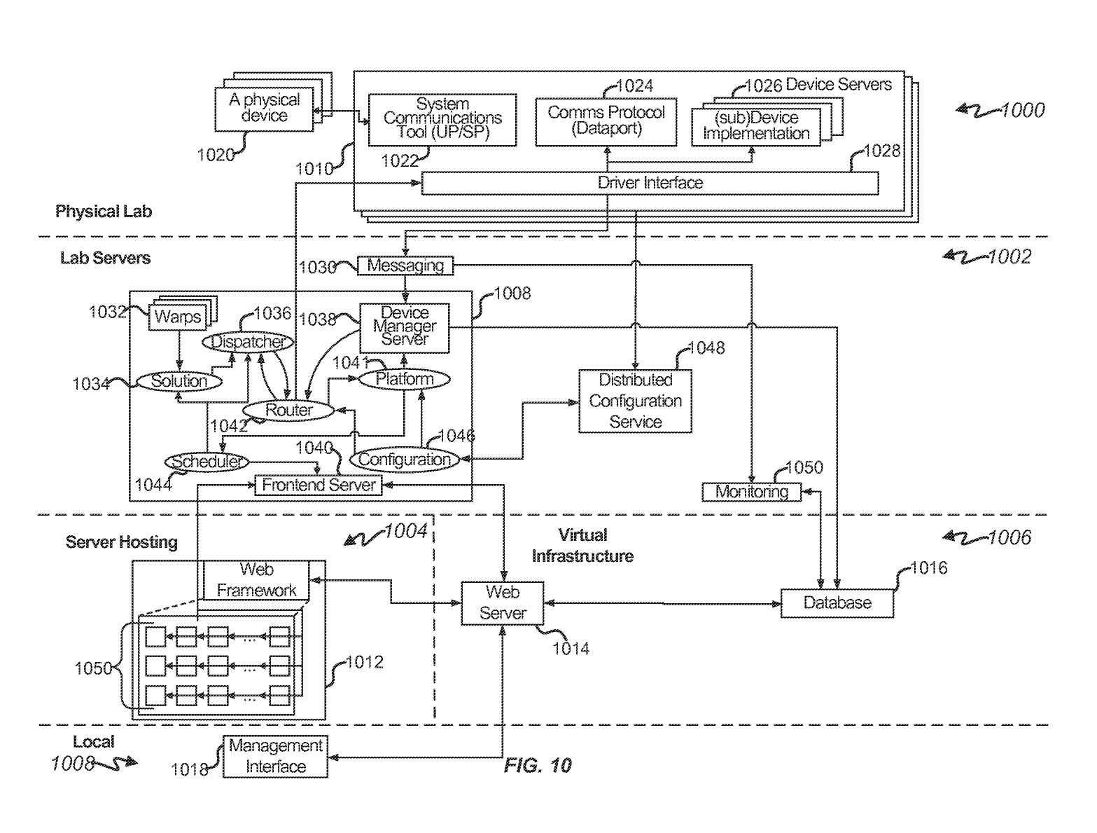

Turning now to FIG. 2, a flowchart of an embodiment of process 200 for protocol sharing is shown. In some embodiments, the data flow is of process 200 of taking protocol code 202 (see FIG. 6), and making transcript 204 of operations (see FIG. 7) that are executed on a platform (see FIG. 10) to achieve results 206. In one embodiment, protocol code 202 is translated into a set of operations (transcript 204), to execute on a site based on a site-specific configuration. The transcript can then be executed on a platform to achieve results.

Results 204 can be information or products. In some embodiments, a transcript is sent to a laboratory to determine information about a process or sample. For example, a sample can be sent to a laboratory for a paternity test. Protocol code 202 can include DNA amplification techniques for the sample followed by a comparison with a control sample. Transcripts 204 can include site-specific operations to perform protocol code 202. Results 206 can include DNA information of the sample and/or a confidence level of a match with the control sample. In another example, a sample of DNA can be sent in for DNA replication. Protocol code 202 can include techniques to replicate the DNA to produce a larger amount of the DNA. Transcripts 204 can include site-specific operations to perform protocol code 202, such as a location of reagents. Results 206 can include information about the amount of DNA produced as well as the replicated DNA itself. In another embodiment, a manufacturer can create specified designs. Protocol code 202 can include descriptions of curves, materials and/or welding procedures. Transcripts 204 can include site-specific operations, including coordination between machinery.

Turning now to FIG. 3, a flowchart of an embodiment of process 300 that uses equipment sharing is shown. In block 302, a researcher can brainstorm ideas in an ideation phase. In block 304, the researcher can review literature and background on one or more ideas. In block 306, with or without the research, the researcher can plan an experiment to test the ideas from block 302. The researcher can select to pursue the experiment using in-house resources in block 308 or virtualized resources in block 310. In block 312, using either block 308 or block 310, the researcher can complete an experiment. In block 314, the researcher can store data observed during block 312. In block 316, the researcher can then perform data analysis on the data stored in block 314. Using that analysis, the researcher can come up with further ideas in block 302.

One of the problems that can stop research is not having access to research resources in block 312. Without resources to perform an experiment, a researcher can be unable to test ideas from ideation block 302. By providing a system that enables sharing resources using a generic langauge, a researcher may no longer be stopped at block 312 and/or 308 for a lack of resources. Equipment can be available to the researcher as virtualized resources in block 310. These resources can appear virtualized to the researcher, as the equipment can be schedulable upon request, and do not require system administration by the researcher. The researcher can instead access the equipment through use of a generic language without need of the site-specific configuration.

Turning now to FIG. 4, a block diagram of an embodiment of sharing management system 400 configured for equipment sharing is shown. Management system 408 can receive protocol code from user computing resource 402 over first network 406. Management system 408 can translate protocol code 404 to a preliminary transcript of operations 436. Site control system 410 can receive the preliminary transcript of operations 436 over second network 412 and schedule the transcript to operate in parallel with other transcripts. After executing transcript 436, site control system 410 can return results and/or logs to management system 408. Management system 408 can return a report of the results of the protocol code to user computing resource 402. In some embodiments, the first and second networks are the Internet. In another embodiment, the first network is the Internet and the second network is a virtual private network. Other network combinations are possible.

The user can create protocol code and submit the code to management system 408. In one embodiment, the user can create code using visual API 414 of management system 408. For example, management system 408 can include a programming environment that determines whether the protocol code is fully specified. User database 420 can be used to store protocol code information and/or user information for use in providing services to the user. Once complete, the protocol code can be submitted directly from visual API 414 or from the user computer to submission API 416. Submission API 416 can store and/or verify the protocol code received.

The protocol code can be its own language, extensions to existing language, compiled, interpreted and/or generated. The programming environment can be a local programming environment or a web-based programming environment. In some embodiments, the high-level language is an existing language that includes language extensions, such as through importing a library such as an Autoprotocol™ library. Computer language can be translated or compiled using a code generator to form an intermediate and/or generic description of the protocol. A code generator 422 can make use of code extensions to translate a computer language into an intermediate state. In other embodiments, a user can implement protocol code in high-level computer language, such as Autoprotocol™. The computer language may not require use of code generator 422 and instead be sent directly for translation and scheduling.

Code generator 422 can receive protocol code 404 from submission API 416, determine a site and receive payment. After receiving protocol code 404 from submission API 416, code generator 422 can determine a set of sites that has capabilities to execute the protocol. The code generator can compare requested operations with site-specific configurations in site configuration database 426. The user can be presented with the selection over web interface 418 provided to the user computing resource, in which the user can manage various constraints and/or costs. For example, the user may select a higher priority constraint which may allow the protocol to complete faster, but costs more. The user can also select constraints over a type of certifications a site must have or a number of repetitions of the protocol that must be completed. After selecting constraints, payment engine 428 can determine a payment for selected services and/or constraints. Payment engine 428 can also communicate with external payment services 430 to facilitate payment.

Code generator 422 can prepare a transcript of protocol code 404 to be scheduled by scheduling engine 424 and implemented by selected site control system 410. Using the user's selected site (which can be stored with other user information in a user database), a site-specific configuration can be retrieved from site configuration database 426. Using the site-specific configuration, the code generator can translate the protocol in a generic language to a transcript of operations in site-specific instructions. The transcript can include a mix of code targeted at a task scheduler and one or more test bench machines. In some embodiments, the code targeted at test bench machines can be compiled instructions for execution on a test bench machine.

In some embodiments, code generator 422 can serve as a verifier to ensure that a protocol specification is completely specified (i.e., can be implemented based on current information). Code generator 422 can be configured to enforce inclusion of information necessary to fully specify a protocol action, protocol constraint or other protocol information. In one embodiment, code generator 422 enforces required parameters and optional parameters in function calls. By enforcing required parameters, a protocol can be fully specified. For example, a mix function may include different required parameters based on the mixing type. An inversion mixing type may not need further specificity other than an amount of time. However, a mixing type of “swirl” may need to include a parameter of time and rotations per minute.

The transcript can be provided to scheduling engine 424 for implementation on site control system 410. Scheduling engine 424 can use the transcript and site-specific configuration from site configuration database 426 to determine an order, timing and/or parallelization of operations from the transcript. In one embodiment, the operations are placed in a directed acyclic graph (DAG) data structure where a vertex represents an operation and a directed edge represents a dependence on an operation. Traversal of the DAG can result in a tree structure, where a parent is dependent on a child node. The tree structure can be verified against additional constraints in the transcript. If the tree structure meets the constraints, scheduled transcript 436 can be created for transmission to site control system 410. In one embodiment, parallel branches of the tree structure can be scheduled for parallel execution subject to equipment constraints.

A scheduled transcript can include multiple types of information. In some embodiments, scheduled transcript 436 includes the tree structure and/or the DAG. In an embodiment, scheduled transcript 436 includes multiple transcripts from multiple protocols that have been scheduled together for implementation on site control system 410. Scheduled transcript 436 can include all or part of transcript and/or protocol code 404 for use in dynamic scheduling of site control system 410. In some embodiments dynamic scheduling can be performed by task scheduler 438 or scheduling engine 424.

Task scheduler 438 within site control system 410 can receive scheduled transcript 436. Using scheduled transcript 436, task scheduler 428 can cause one or more task agents 444 to implement one or more operations from transcript 436. In some embodiments, scheduled transcript 436 can refer to site-specific information stored in task database 440. For example, a scheduled transcript can refer to an automated process of moving sample #1 to machine number 2. Task scheduler 438 or task agent 444 can retrieve information from task database 440 including a variable representing a location of sample #1 as located in storage position #15 and/or a procedure for operating a robot arm to move the sample from storage position #15 to machine number 2. Task agents 444 can interface with test bench machines and other automation through test bench machine interfaces 446. Test bench machine interfaces 446 can include fully automated (e.g., a command that causes a procedure to be performed), semi-automated (e.g., providing a set of operations to perform) and direct control interfaces (e.g., providing each operation, one at a time, over a real-time interface). As operations are performed, log information and observations can be recorded and stored in result database 442.

Task scheduler 438 can transmit information stored in result database 442 to reporting engine 432. Results observed by the test bench machines and log information can be transmitted to reporting engine 432 by task scheduler 438 over network 412. Reporting engine 432 can create a report that represents the results obtained by executing protocol code 404 as requested by the user. The reports can be provided over web interface 418 or through third party services 434 such as email.

A test bench can include equipment that is used to implement the transcript. Test bench can include preparation equipment that is used to store and prepare samples and/or product (e.g., reagent preparation, mixing systems, loading systems, washing systems, etc.). The test bench can include transfer equipment used to move and/or hold samples or products for use (e.g., robotic arms, moving surfaces, belts, etc.). The test bench can include storage equipment that is used to store and prepare samples and/or products (e.g., refrigerators, storage containers, reagent storage, etc.). The test bench can include test equipment that is used to operate on samples and/or products (e.g., heaters, mixers, centrifuges, sensing equipment, etc.).

Task agents can be assigned in multiple ways. For example, a task agent 444 can be assigned operation of a test bench machine. All operations directed at the test bench machine can be assigned to task agent 444. In another example, task agent 444 can be assigned a sample or product. Task agent 444 can then be assigned to ensure proper coordination of the sample and/or product. In one example, task agent 444 can be assigned to a protocol. Task agent 444 can then be responsible for ensuring the transcript of the protocol is executed according to operations and/or constraints.

For example, user computer 402 can upload protocol code 404 consisting of Ruby and Autoprotocol extensions through web interface 418 over network 406 such as the Internet. Using web interface 418, the user can cause web interface 418 to submit protocol code 404 through submission API 416 to code generator 422. Code generator 422 can verify that protocol code 404 is completely specified (i.e., it contains enough information to be executed by site control system 410). Using site configuration database 426, code generator 422 can determine sites that can execute protocol code 404. The list of sites can be presented to a user over web interface 418. Web interface 418 can receive a user selection of one or more sites to execute protocol code 404. Web interface 418 can submit the selection through submission API 416 to code generator 422 and user payment for the use of the site through payment engine 428. Code generator 422 can save the user selection to user database 420. Based on the user selection of a site, a site-specific configuration can be loaded from site configuration database 426 by code generator 422. Code generator 422 can translate protocol code 404 from Ruby and Autoprotocol extensions into a site-specific transcript targeted at test bench machine interfaces 446, task scheduler 438 and task agents 444. The transcript can include machine code for test bench machine interfaces 446 and Java code for task scheduler 438 and task agents 444.

Scheduling engine 424 can receive the transcript from code generator 422. Scheduling engine 424 can combine multiple transcripts together and determine a schedule of operations to perform to result in a scheduled transcript. Using the multiple transcripts, scheduling engine 424 can create a DAG (or sometimes multiple disconnected DAGs) that represents dependencies from tasks. Using the DAG, solutions for traversal can be attempted until a solution is found that meets all given constraints. If a solution is not found, a transcript from the multiple transcripts can be dropped. If a transcript cannot be performed because of constraints, a user can be notified of which constraints would be violated and seek approval and/or correction. The solution can result in scheduled transcript 436 that is transmitted to site control system 410 over network 412, such as the Internet.

Using scheduled transcript 436, task scheduler 428 can implement the schedule. Task scheduler 438 can update scheduled transcript 436 with data from task database 440 which can contain information about variables and procedures relevant to the site (e.g., storage location of samples, storage retrieval operations for each location, etc.). Task scheduler 428 can assign task agents 444 to prepare reagents for use with samples, taking sample readings and washing used containers. Task agents 444 can then execute the operations using test bench machine interfaces 446. Readings and logs of operations can be sent from task agents or directly from test bench machine interfaces 446 to be stored in result database 442. After completion of the transcript, task scheduler 438 can translate result information from result database 442 for use by reporting engine 432. The translated result information can be submitted to reporting engine 432 over network 412. Reporting engine 432 can then provide results and/or logs over web interface 418 or through other services such as email by 3rd party services 434.

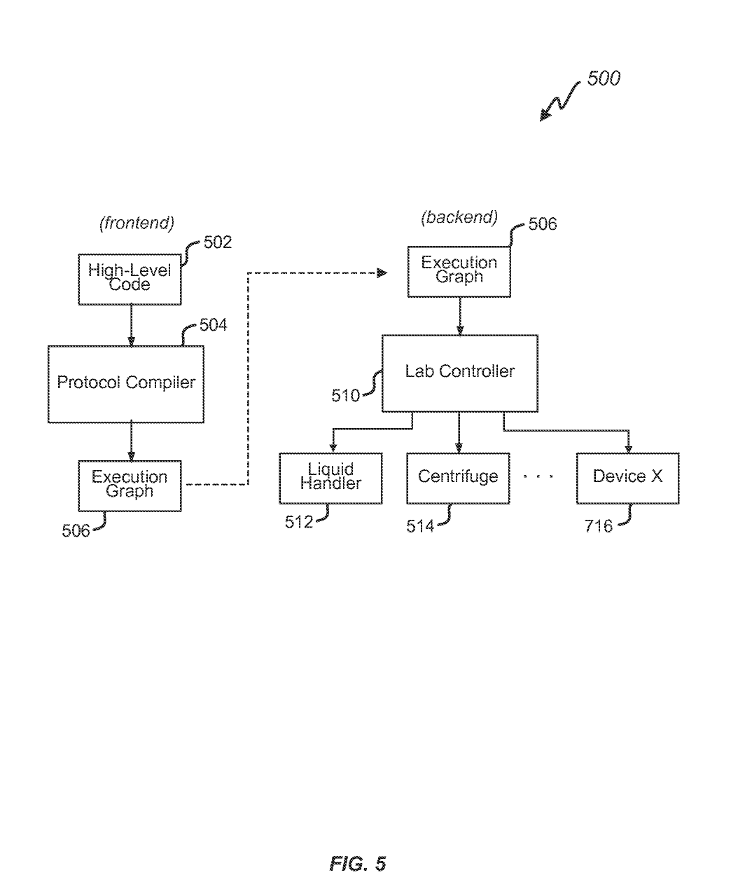

Turning now to FIG. 5, a flowchart of an embodiment of a process 500 for equipment sharing is shown. High-level code 502 (e.g., protocol code) can be created by a user. The user can send high-level code 502 to protocol compiler 504 by way of a frontend customer facing computing resource. Protocol compiler 504 can determine a solution of operations that satisfy constraints of the protocol, which can result in execution graph 506. Execution graph 506 can be transmitted to lab controller 510 in a backend system that does not have user connectivity. Lab controller 510 can implement execution graph 506. As part of an execution, lab controller can control various equipment, such as liquid handler 512, centrifuge 514 and other devices 516.

In some embodiments, lab controller 510 can be enabled with dynamic operation scheduling. Lab controller 510 can execute first execution graph 506 that ends earlier than scheduled. Lab controller 510 can then determine if a second execution graph can be moved up in time. If so, then lab controller 510 can execute operations from the second execution graph. In some embodiments, multiple execution graphs 506 can execute in parallel. With a dynamic scheduler, changes to one execution graph (or predictions of future changes) can cause lab controller 510 to determine if an alternate scheduling of operations meets constraints of execution graphs 506 and system constraints.

Protocol compiler 504 can translate high level code 502 in multiple ways. In one embodiment, high-level code 502 is compiled to executable instructions, such as byte code and/or an executable file for use with lab controller 510. In another embodiment, high-level code 502 is interpreted by lab controller 510, but equipment functionality is linked to a library that executes the requested functionality based on site-specific configuration. In another embodiment, protocol compiler 504 translates high-level code 502 to an intermediate language. The intermediate language is used to determine execution graph 506

Protocol translation can include steps to verify functionality, ensure proper inventory of reagents and samples, and optimize operations to ensure constraints are met and costs are minimized. In one embodiment, protocol translation can use static analysis and verification for inventory management and optimization. Static analysis and verification can provide assurance that protocol code is fully specified and that requests are within acceptable boundaries.

In FIGS. 6 and 7, examples of code are given. In FIG. 6, an example of a high-level protocol description is given based on Ruby™ syntax with Autoprotocol™ library extensions. In FIG. 7, an example is provided of a site-specific instruction format in a human-readable form (manual operation/no automation) based on the high-level protocol description in FIG. 6.

Turning now to FIG. 6, a chart of an example of code configured to extract a bacteria culture is shown. The protocol code is constructed in Ruby syntax with a library to provide functionality, including Culture.find, extract, spin, mix, add wait, Chemical.find methods. The code execution is defined by a definition of a new protocol in statement 602. Execution starts with statement 612 that requests a plasmid solution be stored in cold. A plasmid solution is defined in statement 610, which requests a new column be prepared. A column is defined in statement 608, which requests a new extraction be prepared. A new extraction is defined by function 606, which requests a bacteria culture be sampled. The bacteria culture is obtained from a culture called “ecoli_gfp” in statement 604.

In some embodiments, statements can include required and optional parameters. Optional parameters can include the “:cold” parameter from statement 612, which identifies a constraint on storage. Required parameters can include “12500.rpm” and “2.minutes” from statement 610.

Turning now to FIG. 7, a chart of an example of code from FIG. 6 that is translated into a human-readable format is shown. Code from FIG. 6 can be translated for a specific output. In the embodiment shown in FIG. 7, FIG. 6 was translated with a directed output of human-readable form as shown in FIG. 7. The instructions 700 can be used in a manual lab to perform the protocol as specified in protocol 600 shown in FIG. 6.

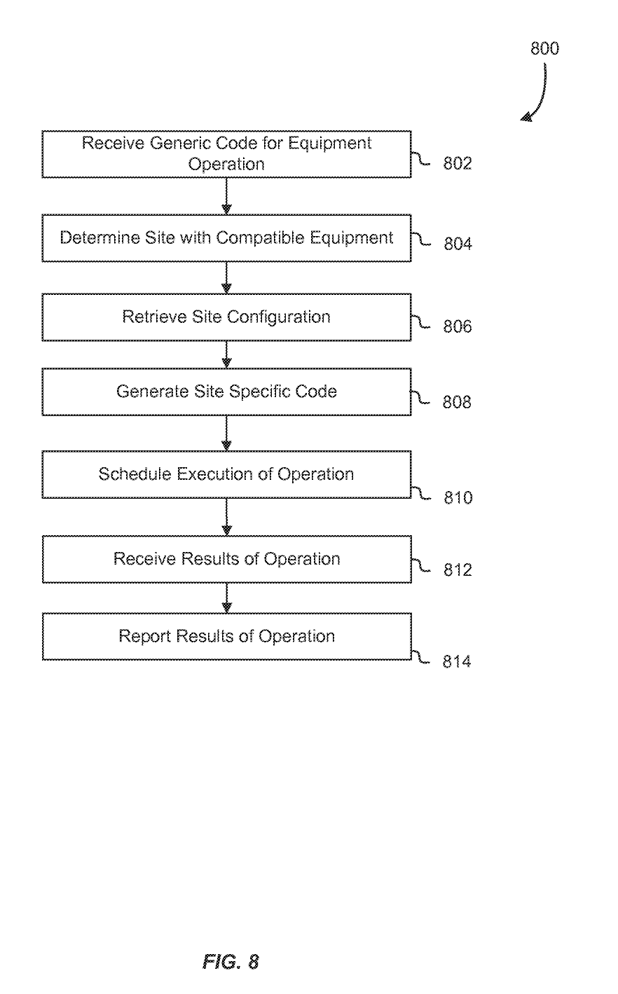

Turning now to FIG. 8, a flowchart of an embodiment of a process 800 for generating site-specific code for equipment sharing is shown. The process can be performed by a system as seen in FIG. 4, including management system 408 and site control system 410. In block 802, lab server can receive protocol code that describes operation of equipment. Using the received code in block 804, a site can be determined based on the site ability to execute actions requested by the protocol code (e.g., requested equipment exists at the site). In block 806, a site-specific configuration can be retrieved to aid in the translation of the protocol code to a transcript of operations. In block 808 and based on the site-specific configuration, the lab server can generate site-specific code for execution on lab server and/or drivers. The lab server can then schedule the transcript to be executed in block 810. In some embodiments, the execution can be in parallel with other transcripts. After execution of the transcript and in block 812, the lab server can receive results of the execution in 810, including log information and observations recorded by equipment. In block 814, the results can be reported to a user, such as via a webpage on a web server, and/or stored for later retrieval.

By enabling repetition across multiple sites, results can be confirmed. Repeatability can be an important part of trust in results from experiments. By allowing a user to repeat an experiment across two different providers with the same instructions, the user and others can have a greater trust in significant results.

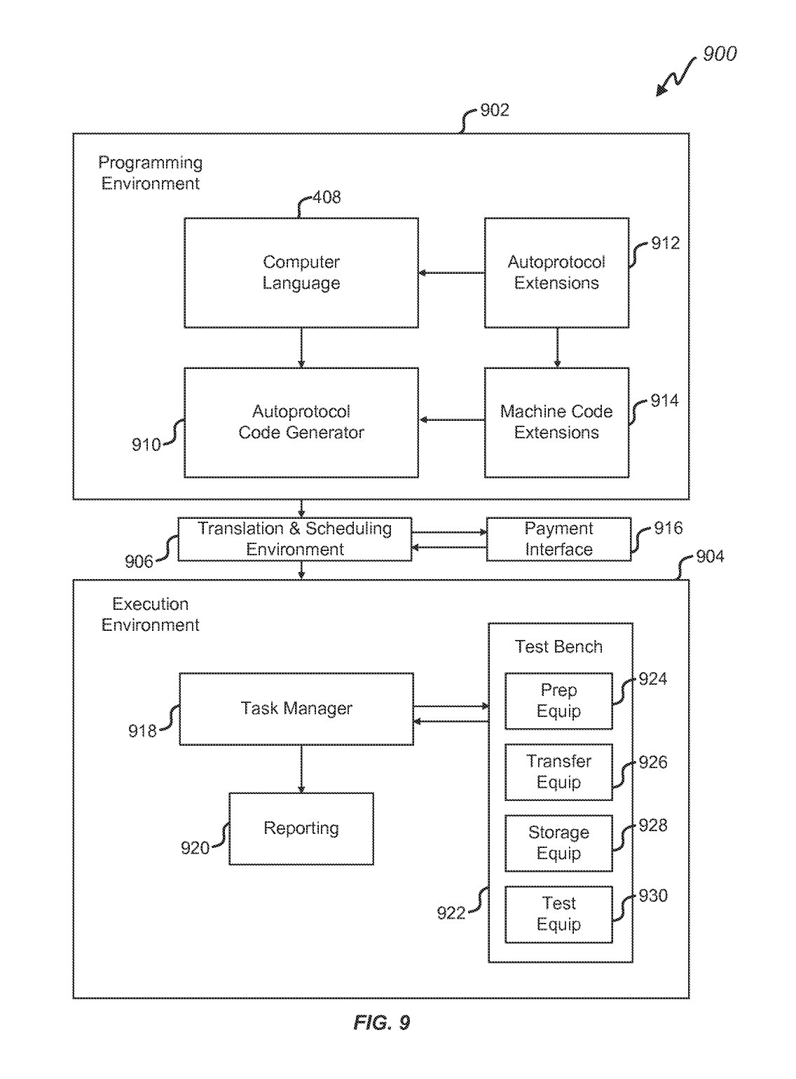

Turning to FIGS. 9 and 10, example block diagrams of an equipment-sharing system are shown. In FIG. 9, an overview of an equipment sharing system is shown to include a programming environment, a translation & scheduling environment and execution environment. In FIG. 10, a block diagram shows computing resources within a physical lab, lab servers, server hosting, virtual infrastructure and local resources.

Turning now to FIG. 9, a block diagram of an embodiment of an equipment sharing service 900 is shown. An equipment sharing service can include a programming environment 902, translation & scheduling environment 906 and execution environment 904. A user can create protocol code in programming environment 902. When the protocol code is complete, the user can transmit the protocol code to translation & scheduling environment 906. Translation & scheduling environment 906 can translate the protocol code to a scheduled transcript of operations. The scheduled transcript of operations can be transmitted to execution environment 904 to be performed at a specific site. The execution environment can then report results of executing the protocol.

The programming environment can include computer language 908, language extension 912, code generator 910 and machine code extensions 914. The protocol code can be its own language, extensions to existing language, compiled, interpreted and/or generated. The programming environment may be a local programming environment or a web-based programming environment.

In some embodiments, the high-level language is an existing language that includes language extensions, such as through importing a library such as an Autoprotocol™ library. Computer language 908 can be translated or compiled using a code generator to form an intermediate and/or generic description of the protocol. Code generator 910 can make use of code extensions 914 to translate computer language 908 into an intermediate state.

In other embodiments, a user can implement protocol code in high-level computer language 908, such as Autoprotocol™. The computer language may not require use of code generator 910 and instead be sent directly for translation and scheduling.

In some embodiments, code generator 910 can serve as a verifier to ensure that a protocol specification is completely specified (i.e., can be implemented based on current information). Code generator 910 can be configured to enforce inclusion of information necessary to fully specify a protocol action, protocol constraint or other protocol information. In one embodiment, code generator 910 enforces required parameters and optional parameters in function calls. By enforcing required parameters, a protocol can be fully specified. For example, a mix function may include different required parameters based on the mixing type. An inversion mixing type may not need further specificity other than an amount of time. However, a mixing type of “swirl” may need to include a parameter of time and rotations per minute.

When the protocol code is complete, it can be submitted to translation and scheduling environment 906. Translation and scheduling environment 906 can take the protocol code and adapt it for use and cause it to be executed in execution environment 904. The translation and scheduling environment can allow a user to submit the protocol for execution, select an environment for execution, provide a priority of execution and pay for services requested and/or rendered. The translation and scheduling environment can process the protocol code from programming environment 902 to produce a transcript for running in execution environment 904.

Translation and scheduling environment 906 can be a set of servers that provides an interface to programming environment 902 and execution environment 904. In one embodiment, translation and scheduling environment 906 is a set of servers accessible at a URL on the Internet. Translation and scheduling environment 906 receives protocol code from a user. Using the protocol code and site-specific configurations from execution environments 904, translation and scheduling environment 906 determines one or more execution environments that can execute the protocol code. Translation and scheduling environment 906 can then present the one or more execution environments 904 to the user and receive a selection from the user of compatible execution environment 904. Translation and scheduling environment 906 can then bill the user for resource allocation using payment interface 916. Based on the user selection, a site-specific configuration can be used to translate the protocol code to a transcript of operations to use in the execution environment. The transcript can then be transmitted to execution environment 904 for execution. In some embodiments, a report of results from execution of the transcript can be returned to translation and scheduling environment 906 and made available to the user.

Execution interface 904 can receive scheduled transcripts and implement the transcript. In some embodiments, the scheduled transcripts can include more than one protocol, allowing multiple protocols to execute in parallel. In one embodiment, task manager 918 can be capable of dynamic scheduling. Dynamic scheduling allows a first set of operations to be rescheduled, such as moved up in schedule, when a second set of operations completes early. For example, a protocol may require that a reagent be added and mixed until it achieves a desired color. Beforehand, the amount of reagent may not be known, so the set of operations can include a schedule for a maximum number of reagent additions and mixing. However, the maximum number can be unlikely to be reached. A dynamic scheduler of task manager 918 can allow the unneeded operations to be removed from the schedule and replaced with other operations.

In one embodiment, the schedule can be described with a tree data structure using warps. The dynamic scheduler can remove or mark as complete any nodes that are associated with an early completing set of operations. The remaining nodes can be analyzed to determine if they meet all constraints. Should a constraint not be met, the dynamic scheduler can search for alternate solutions and/or provide a wait command in place of a deleted operation when needed.

Task manager 918 can communicate with one or more machines of test bench system 922 and receive information for reporting system 920. Task manager 918 can coordinate and/or control the equipment from test bench 922. Test bench 922 can include equipment 924, 926, 928 and 930 that is used to implement the transcript. Test bench 922 can include preparation equipment 924 that is used to store and prepare samples and/or product (e.g., reagent preparation, mixing systems, loading systems, washing systems, etc.). Test bench 422 can include transfer equipment used to move and/or hold samples or products for use (e.g., robotic arms, moving surfaces, belts, etc.). Test bench 922 can include storage equipment 928 that is used to store and prepare samples and/or products (e.g., refrigerators, storage containers, reagent storage, etc.). Test bench 922 can include test equipment 930 that is used to operate on samples and/or products (e.g., heaters, mixers, centrifuges, sensing equipment, etc.).

Task manager 918 can interoperate with, coordinate with, communicate with and/or direct equipment from test bench 922. Task manager 918 can be configured to work with equipment having various abilities for autonomy. Task manager 918 can assume direct control over test bench equipment through a hardware interface. Task manager 918 can also transmit commands to a more autonomous machine and await a success or failure. The task manager can also send a request to an automous piece of equipment to perform a desired protocol and await the results for reporting to reporting system 920.

Reporting system 920 can provide information about the results and/or success of implementing the protocol. In some embodiments, reporting system 920 receives readings from test bench 922 or task manager 918 for storage and later reporting to the user. Reporting system 920 can also include logs of the success, failure and/or timing of operations or steps performed by the task manager. These readings and/or logs can be transmitted to the user as one or more reports. In one embodiment, translation and scheduling environment 906 creates a report from data received by reporting system 920 and transmits the report for display to the user.

Turning now to FIG. 10, a block diagram of an embodiment of a management system configured for physical device sharing is shown. The block diagram is divided into locations including physical lab 1000, lab servers 1002, server hosting 1004, virtual infrastructure 1006 and local resources 1008. An administrator can administer the system through management interface 1018 to web server 1014. Webserver 1014 can communicate with server hosting 1004 to translate protocol code to transcripts for use by lab servers 1002. Lab servers 1002 including lab system 1008 can communicate with device servers 1010 that interface with physical devices 1020.

An administrator can administer physical device sharing through management interface 1018 provided on local computing resources. In some embodiments, management interface 1018 can be a command line interface (CLI). In other embodiments, management interface 1018 can be a web-based interface delivered through HTML, AJAX and/or JavaScript. Management interface 1018 can include a dashboard describing state and/or operation information of some or all components and/or resources of the physical device sharing system. Management interface 1018 can also provide access to modify, update, change and/or add components, information, configuration and/or other systems to the physical device sharing system.

Virtual infrastructure 1006 can be used to satisfy requests and/or accesses of users of the physical device sharing system. Web server 1014 backed by database 1016 can be used to provide services to users of the physical device sharing system. The virtual infrastructure can include distributed computing resources, allowing web server 1014 and database to service many concurrent requests. For example, web server 1014 can include load balancing systems that direct requests to application servers. The application servers can support protocol code submissions and reports for users of the physical device sharing system. The application servers can communicate with database servers 1016 that provide stored information, such as reports and protocol code. When more servers are required, virtual infrastructure 1006 can create and add more computing resources to the load balancing systems, application servers and/or databases.

The web server can communicate with one or more instances of servers 1012 in hosting environment 1004. Each server 1012 can include a web framework with multiple instances 1050 of services that manage and support lab servers 1008. In one embodiment, service instance 1050 recieves protocol code from web server 1014. Service instance 1050 performs translation of protocol code to a transcripton of operations. The transcription can be sent to lab server 1008 for scheduling.

Lab server 1008 can use a transcription to schedule and perform operations implementing the protocol code. Frontend server 1040 can provide APIs for available services, such as receiving a transcript. Using a received transcript, scheduler 1044 can request solution constructor 1034 to implement a transcript. The transcript can be broken down into a hierarchy of warps 1032. Using the hierarchy of warps 1032, branches of potential solutions can be explored and/or constructed such that each branch of the hierarchy satisfies constraints of the transcript and/or local configuration 1046. When solution constructor 1034 finds a solution, scheduler 1044 can request dispatcher 1036 implement the solution. Using site configuration 1046, router 1042 can coordinate lab equipment physical devices 1020 using drivers 1010 managed by device manager server 1038. Messages from drivers 1010 can be received though messaging protocols 1030, device manager server 1038 and/or router 1042.

In some embodiments, a solution is determined directly from protocol code. Protocol code can be analyzed directly by lab server 1008. Solution constructor 1032 can translate protocol code to operations for use in creating warps 1032. The warps can then be translated to a solution. An instruction can be pipette or incubate and a warp or a low level hardware command is what the instruction extends into. For instance, an incubate instruction may expand into robotic arm movements including open the incubators, store the plate, and move the robotic arm. Each one of those operations may be a warp. Embodiments provide the planning mechanism that converts the instructions into a series of warps or warp commands.

Lab server 1008 configuration can be managed by distributed configuration service 1048. Distributed configuration service 1048 can ensure that lab servers 1002, including lab server 1008, maintain current configuration and drivers 1010. Distributed configuration service 1048 can communicate with lab server 1008, to update information including configuration 1046, platform 1041 (such as operating system, frameworks, etc.) and drivers 1010.

Lab server 1008, drivers 1010, physical devices 1020 and other system resources can be monitored by monitoring system 1050. Monitoring system 1050 can ensure that systems are operating as specified, predict failure and report failure. For example, monitoring system 1050 can determine that scheduled transcript execution is taking longer than expected using lab server 1008. Monitoring system 1050 can store this information in database 1016. Web server 1014 can cause server 1012 to avoid use of lab server 1008 if possible and notify an administrator of the issue.

Drivers 1010 can receive operations and/or commands from router to driver interface 1028. Driver interface 1028 can then implement the operations and/or commands through available communication interfaces, such as systems communications tool 1022 (e.g., networking protocols) and/or comms protocol 1024 (e.g., a hardware port). In some embodiments, a set of devices is grouped together and treated as one device (e.g., a robotic arm dedicated to a machine and the machine itself). In the grouped devices, sub device drivers 1026 can be used so that a group driver communicates with a device driver that operates a physical device.

In one example, a client can submit protocol code by web server 1014. Web server 1014 can send the protocol code to server 1012 through a web framework to service 1050. Service 1050 determines a site that can complete the protocol code. Service 1050 sends the protocol code to lab server 1008. Lab server 1008 can send the protocol code to scheduler 1044 that causes solution constructor 1034 to translate the protocol code into operations within a data structure of warps 1032 that satisfy constraints of the protocol code and site configuration 1046. When a solution is found, a scheduled transcript of operations is sent to dispatcher 1036 that routes the scheduled transcript to drivers 1010. Drivers 1010 cause physical devices 1020 to perform the requested operations. Results are sent back to server 1008, such as via messaging system 1030. The results can then be sent to web server 1014 directly and/or through monitoring system 1050. Web server 1014 can store the results in database 1016 and prepare a report to deliver to a user.

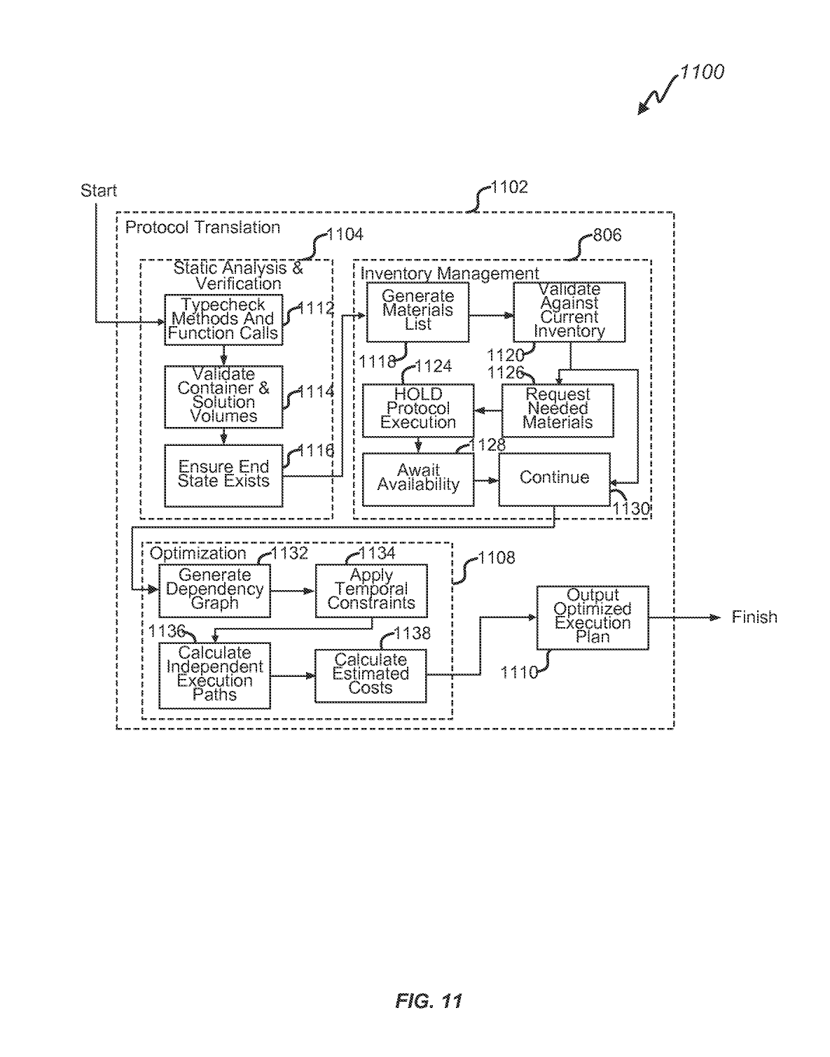

In FIG. 11, a flowchart shows a process of translating high-level code to site-specific operations. In FIG. 11, a process of translation of a protocol written in a high-level language into an optimized execution plan is shown.

Turning now to FIG. 11, a flowchart of an embodiment of example process 1100 for scheduling equipment sharing is shown. Process 1100 can be performed by a server (e.g., lab server 1008 receiving code from service 1050 in FIG. 10). Protocol translation can include steps to verify functionality, ensure proper inventory of reagents and samples, and optimize operations to ensure constraints are met and costs are minimized. In the embodiment shown, protocol translation 1102 can use static analysis and verification 1104 to inventory management 1106 and optimization 1108.

Static analysis and verification 1104 can provide assurance that protocol code is fully specified and that requests are within acceptable boundaries. A server can receive protocol code submitted by a user. Protocol translation in block 1102 can start with static analysis and verification in block 1104. Variables, methods and function calls can be statically checked to adhere to declared types in block 1112. Use of language extensions and/or libraries can be verified as syntactically correct. In some embodiments, the typechecking can also ensure that necessary constants, variables, constraints and/or parameters are present to fully specify the protocol code. In block 1114, container & solution volumes can be checked to ensure that the containers are compatible with requested additions, reactions and/or subtraction operations. For example, this check can include verifying that containers are large enough, but that they are not too large such that pipette operations have too small of a clearance with the bottom of a container. In another example, a reagent can be checked in a database on whether it is compatible with a specified container material. In block 1116, the program can be verified to contain an exit state such that the protocol will eventually exit. In some embodiments, the exit state can be confirmed by an eventual timeout. If an error is found in these checks, the system can return an error and explanation of the problem. In some embodiments, an error will prevent further progress. In other embodiments, the system can continue to process the protocol to provide any further errors. In one embodiment, different error levels exist such that smaller errors are enabled to continue processing, while larger errors cause processing to stop.

Once static analysis & verification in block 1104 are complete, inventory management 1106 checks can start. In block 1118, a materials list is generated from the program code to determine what materials are needed to complete the protocol code. In block 1120, the materials list is validated against current inventory to make sure there is enough inventory to complete the protocol code. If all materials are found available in block 1120, the process can continue to optimization 1108. If not, the process can be held in block 1124 until the materials become available in block 1128. Once the materials are found, the process can continue in block 1130 to optimization in block 1108.

After inventory is determined and made available, an optimization process can begin in block 1108. In block 1132, a dependency graph of operations can be constructed. In some embodiments, constraints, such as temporal constraints, can be applied to the dependency graph in block 1134. In block 1136, paths of execution (e.g., an order of execution of operations) that satisfy constraints can be calculated. In block 1138, the determined paths can be measured for estimated costs, such as time, money and parallelization with other protocols. In block 1110 and using the costs, an optimized execution plan can be selected based on the estimated costs.

In one example, protocol code shown in FIG. 6 can be submitted through a web interface for protocol translation by a user. The protocol code can be given to a lab server for translation. In block 1112, the protocol code can then type checked for valid typed information (e.g., spin function calls have a first parameter of rpm, a second parameter of time and a third optional parameter which specifies which part of the sample to keep). In block 1114, the server can then check the protocol code for worst case scenarios as to container size (although, in some embodiments, a constraint can override this behavior). Site containers can be verified to hold at least (1.5 mL+250 uL+250 uL+350 uL+750 uL+50 uL equals) 3.15 mL. In block 1116, the protocol can be verified to end after statement 612 calls statement 610, which calls statement 608, which calls function 606, which calls statement 604.

The protocol code from FIG. 6 can then be processed through inventory management in block 1106. A materials list can be generated in block 1118 to include 1.5 mL of ecoli gfp, 250 uL of quiagen_p1, 250 uL of quiagen_p2, 350 uL of quiagen_n3, 750 uL of quiagen_pe and 50 uL of de-ionized water. In some embodiments, the reagents can be provided by on-site service providers. In other embodiments, reagents can be sent to the service provider by the user. The amounts from the materials list can be compared against current material levels in block 1120. If materials are not sufficient and/or not present, the server can request the materials be provided in block 1126. The user and/or service provider can be provided notice and an ability to provide the missing inventory, while execution holds in block 1124 until the inventory becomes available in block 1128. Once the inventory is available, processing of the protocol code can continue in block 1130.

After inventory is confirmed, the protocol code can be optimized in block 1108. A dependency graph of operations can be generated in block 1132. Protocol code statements in FIG. 6 can be converted to site-specific operations, such as those shown in FIG. 7. In some embodiments, the dependency graph is a directed acyclic graph where nodes represent operations and the edges represent a first operation depending on a second operation. Constraints, such as temporal constraints, can be applied to the dependency graph in block 1134. Constraints can include site constraints and/or constraints provided in the protocol code. For example, statement 612 requests that the resulting product be stored in a cold environment. Independent execution paths of the dependency can be determined in 1136. The execution paths can then have costs assigned to the paths in 1138. Costs can include time, money, interference with other protocols, additional operations, additional complexity and/or difficulty (e.g., a process having a tight timing requirement versus a process that has a relaxed timing requirement). Using weights provided by the user, administrator of the system, administrator of the site and/or historical context (e.g., how well tight timing requirements have gone in the past), an optimized execution plan can be output (see e.g., FIG. 7 as a human-readable optimized execution plan for protocol code in FIG. 6).

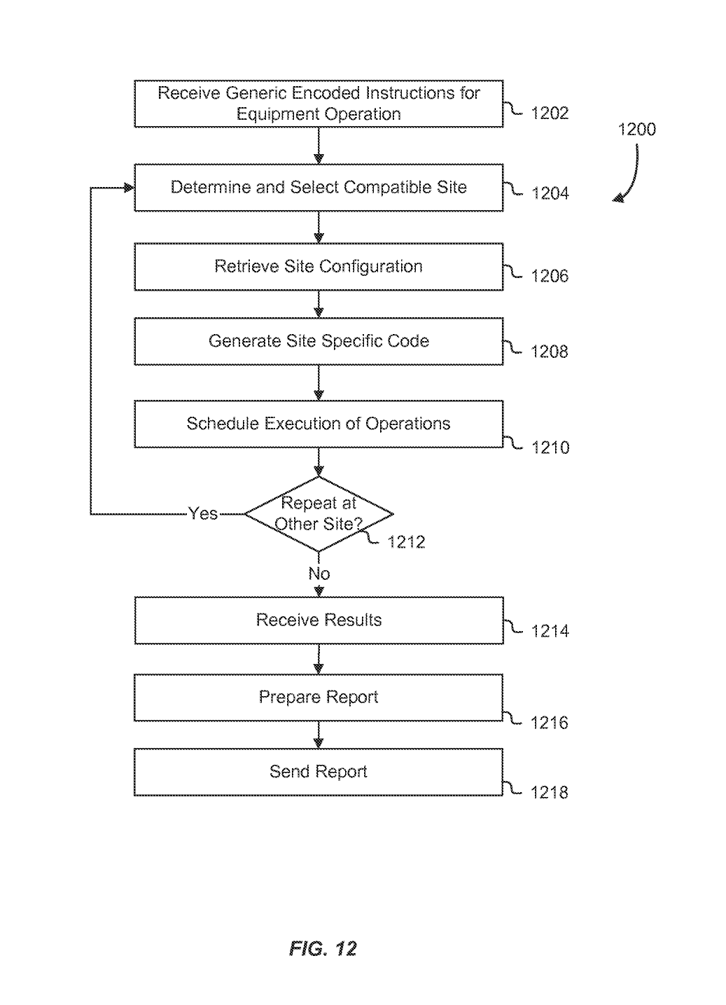

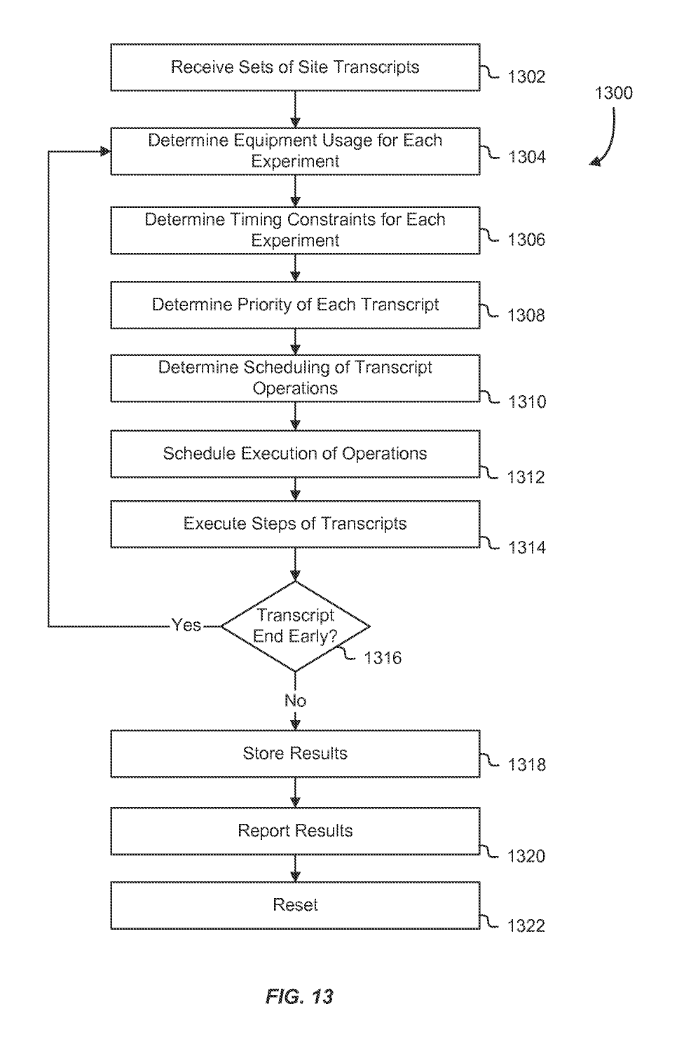

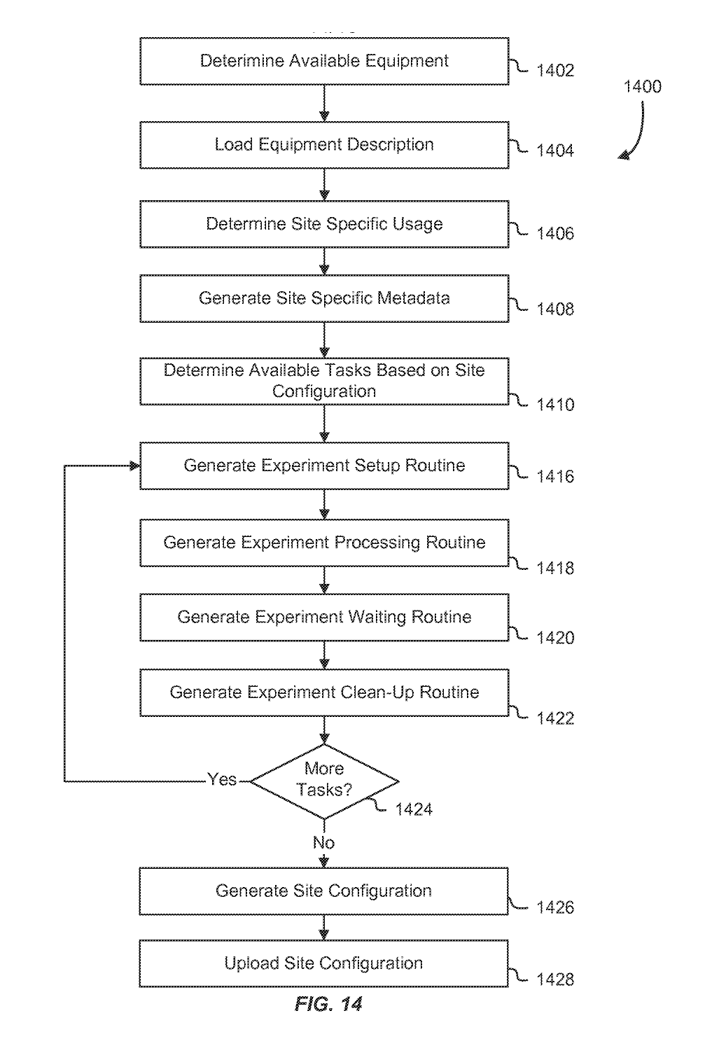

In FIGS. 12 to 14, example processes are shown to use equipment sharing systems. In FIG. 12, a flowchart shows a process for repeating experiments across multiple sites. In FIG. 13, a flowchart shows a scheduling process for executing multiple parallel experiments. In FIG. 14, a flowchart shows a site configuration construction process.

Turning now to FIG. 12, a flowchart of an embodiment of a process 1200 for repeating experiments using equipment sharing is shown. The process can be performed by a system as seen in FIG. 10, including web server 1008, server 1012, lab server 1008, drivers 1010 and/or physical device 1020. In block 1202, the lab server can receive protocol code that describes operation of equipment. Using the received code in block 1204, a set of compatible sites can be determined, based on a site ability to execute actions requested by the protocol code (e.g., requested equipment exists at the site). A compatible site can be selected from the set of compatible sites. In block 1206, the site-specific configuration can be retrieved to aid in the translation of the protocol code to a transcript of operations. In block 1208 and based on the site-specific configuration, the lab server can generate site-specific code for execution on lab server and/or drivers. The lab server can then schedule the transcript to be executed in block 1210. In some embodiments, the execution can be in parallel with other transcripts. In block 1212, the protocol code can be selected for adaptation and repetition to other sites. If repetition is selected in block 1212, a site selection can repeat, starting at block 1204. If repetition is not selected in block 1212, results of the one or more repetitions of protocol code can be received in block 1214, including log information and observations recorded by equipment. In block 1216, results can be formatted into a report. In some embodiments, reports can aggregate information from multiple repetitions of the protocol. In block 1218, the results can be reported to a user, such as via a webpage on a web server, and/or stored for later retrieval.

Turning now to FIG. 13, a flowchart of an embodiment of a process 1300 for dynamic scheduling of shared equipment is shown. The process can be performed by a system as seen in FIG. 10, including web server 1008, server 1012, lab server 1008, drivers 1010 and/or physical device 1020. Some experiments can have conditions that cause experiments to end early. For example, a measurement using a reagent can be added until a color change is obtained (e.g., pH testing). The measurement can take a few drops or multiple milliliters of reagent, each added a drop at a time. Using normal scheduling, a process can be scheduled to perform the task and then wait until a maximum time for the operation is complete (e.g., the worst case scenario). However, a dynamic scheduling system can allow other operations to reschedule and move up in time.

In block 1302, a dynamic scheduling system can receive a plurality of transcripts to execute on site equipment. In block 1304, equipment usage for each transcript can be determined. In block 1306, constraints, such as timing constraints, can be determined. In block 1308, transcript priority can be determined in relation to other transcripts (e.g., a transcript has priority access to equipment over other transcripts). Using determined equipment usage, constraints and priority, operations from the set of transcripts can be scheduled to operate such that the set of transcripts operates in parallel fashion if possible in block 1310. By using the scheduled transcripts, the lab server can schedule execution of the transcripts in block 1312. The schedule can be executed by the lab server, drivers and physical devices in block 1314. If an operation completes early in block 1316, a rescheduling process can be performed by returning to block 1304 (in one embodiment, if a process takes too long in block 1316, a rescheduling process can also occur). The rescheduling process can potentially reuse information from the first scheduling, such as DAGs, warps, other data structures and data. Once a transcript has completed, results can be stored in block 1318. In block 1320, results can be reported as they come in and/or in an aggregated fashion. After one or more transcripts have completed, a clean-up routine can be performed to reset for further transcript processing in block 1322.

Turning now to FIG. 14, a flowchart of an embodiment of process 1400 for creating a configuration for using shared equipment is shown. The process can be performed by a system as seen in FIG. 10, including web server 1008, server 1012, lab server 1008, drivers 1010 and/or physical device 1020. In block 1402, a lab server can determine available equipment available on site. In some embodiments, the lab server can query various interfaces and discover lab equipment. In other embodiments, the lab equipment can receive a manifest of equipment available. In block 1404 and based on the determined equipment, a description of equipment and a description of available capabilities can be determined. In one embodiment, descriptions can include site-specific code and translations of protocol code to operations. In block 1406, the description can be narrowed by site-specific limitations (e.g., the robotic arm only services a specific machine from a sample tray at a location). Meta data describing machine capabilities and inter-machine operations can be generated in block 1408.

In block 1410, capabilities can be combined into sets of operations to accomplish a larger task, such as an experiment. In blocks 1416 to 1422 and for each task, groups of operations common to a desired outcome can be grouped into a routine. In block 1416, setup routines can be prepared (e.g., the preparation and/or stocking of standard solutions and/or reagents). In block 1418, processing routines can be prepared (e.g., transferring a sample from storage to a machine for examination, taking a reading and returning the sample). In block 1420, waiting routines can be prepared (e.g., placing a sample in a holding bin, refrigerator or heater). In block 1422, clean-up routines can be prepared (e.g., cleaning machines, preparing machines for a powered-off state, washing test materials, etc.). If more tasks are known, the lab server can prepare setup, processing, waiting and clean-up routines for the other known tasks. In block 1426, information determined through the prior operations can be stored in a site-specific configuration. This site-specific configuration can include available equipment, equipment capability descriptions, site limitations, meta data and routines.

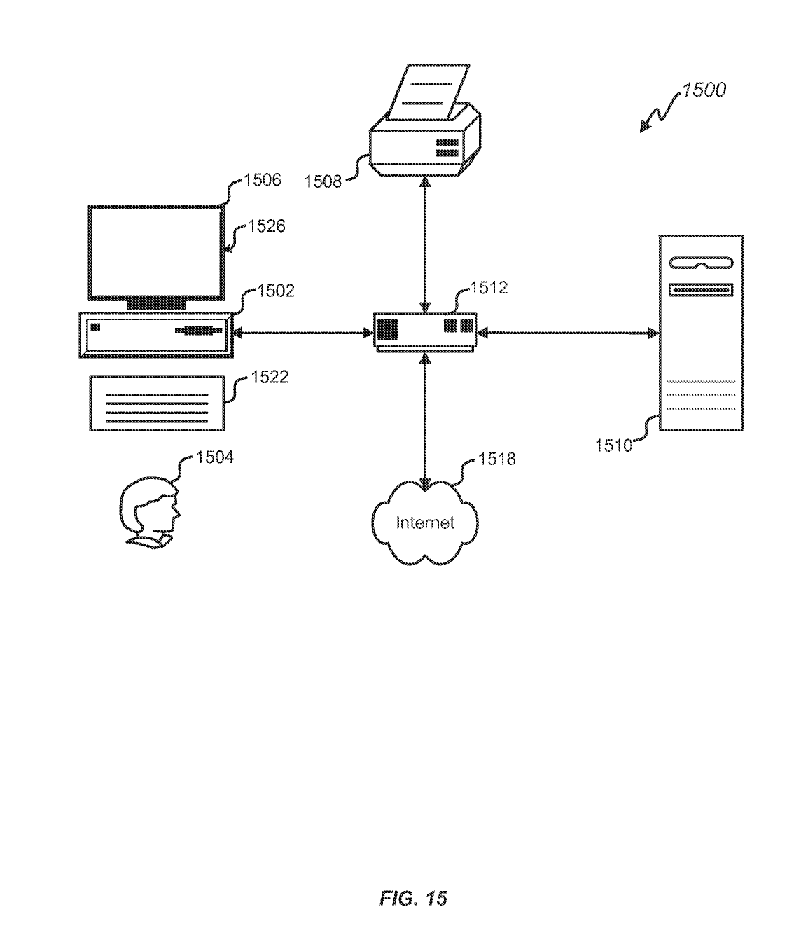

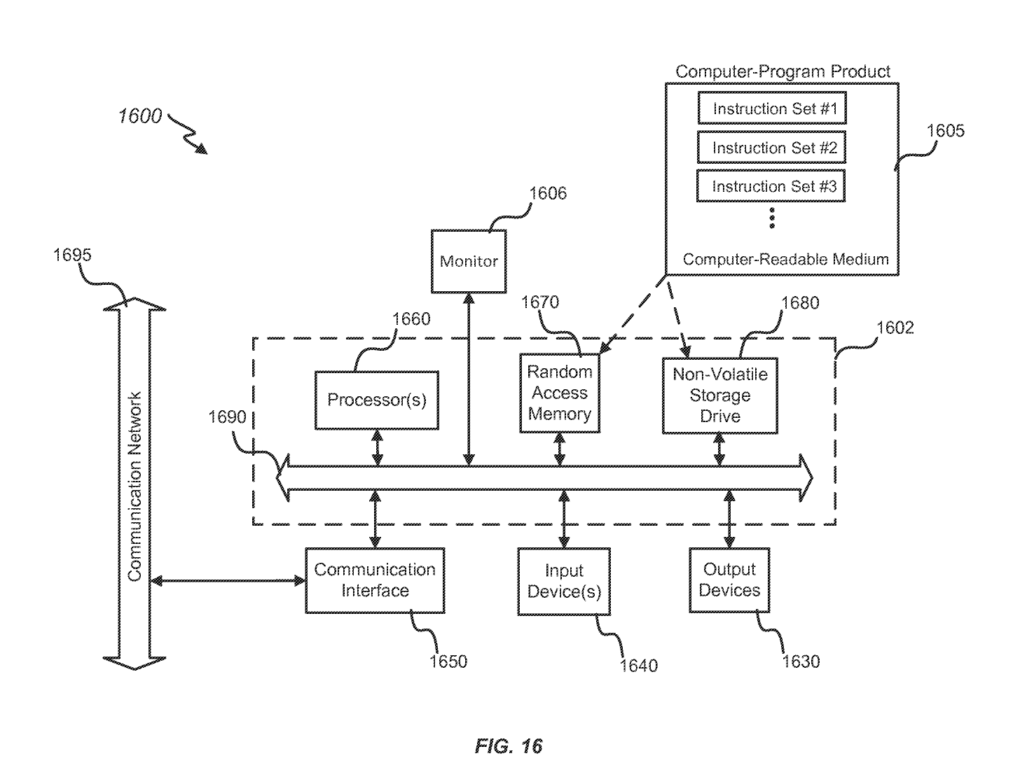

In FIGS. 15 and 16, computing environments are shown. FIG. 15 shows a set of connected computing resources. FIG. 16 shows an environment within a special-purpose computer system.

Referring next to FIG. 15, an exemplary environment with which embodiments may be implemented is shown with computer system 1500 that can be used by designer 1504 to design, for example, without limitation, electronic designs. Computer system 1500 can include computer 1502, keyboard 1522, network router 1512, printer 1508, and monitor 1506. Monitor 1506, processor 1502 and keyboard 1522 are part of computer system 1526, which can be a laptop computer, desktop computer, handheld computer, mainframe computer, etc. Monitor 1506 can be a CRT, flat screen, etc.

Designer 1504 can input commands into computer 1502, using various input devices, such as a mouse, keyboard 1522, track ball, touch screen, etc. If computer system 1500 comprises a mainframe, designer 1504 can access computer 1502, using, for example, without limitation, a terminal or terminal interface. Additionally, computer system 1526 may be connected to printer 1508 and server 1510, using network router 1512, which may connect to Internet 1518 or a WAN.

Server 1510 may, for example without limitation, be used to store additional software programs and data. In some embodiments, software implementing the systems and methods described herein can be stored on a storage medium in server 1510. Thus, the software can be run from the storage medium in server 1510. In another embodiment, software implementing the systems and methods described herein can be stored on a storage medium in computer 1502. Thus, the software can be run from the storage medium in computer system 1526. Therefore, in this embodiment, the software can be used whether or not computer 1502 is connected to network router 1512. Printer 1508 may be connected directly to computer 1502, in which case, computer system 1526 can print whether or not it is connected to network router 1512.

With reference to FIG. 16, an embodiment of special-purpose computer system 1600 is shown. The above methods may be implemented by computer-program products that direct a computer system to perform the actions of the above-described methods and components. Each such computer-program product may comprise sets of instructions (codes) embodied on a computer-readable medium that directs the processor of a computer system to perform corresponding actions. The instructions may be configured to run in sequential order, or in parallel (such as under different processing threads), or in a combination thereof. After loading the computer-program products on general purpose computer system 1526, it is transformed into special-purpose computer system 1600.

Special-purpose computer system 1600 comprises computer 1602, monitor 1606 coupled to computer 1602, one or more additional user output devices 1630 (optional) coupled to computer 1602, one or more user input devices 1640 (e.g., keyboard, mouse, track ball, touch screen) coupled to computer 1602, optional communications interface 1650 coupled to computer 1602, computer-program product 1605 stored in a tangible computer-readable memory in computer 1602. Computer-program product 1605 directs system 1600 to perform the above-described methods. Computer 1602 may include one or more processors 1660 that communicate with a number of peripheral devices via bus subsystem 1690. These peripheral devices may include user output device(s) 1630, user input device(s) 1640, communications interface 1650, and a storage subsystem, such as random access memory (RAM) 1670 and non-volatile storage drive 1680 (e.g., disk drive, optical drive, solid state drive), which are forms of tangible computer-readable memory.

Computer-program product 1605 may be stored in non-volatile storage drive 1680 or another computer-readable medium accessible to computer 1602 and loaded into memory 1670. Each processor 1660 may comprise a microprocessor, such as a microprocessor from Intel® or Advanced Micro Devices, Inc.®, or the like. To support computer-program product 1605, computer 1602 runs an operating system that handles communications of product 1605 with the above-noted components, as well as the communications between the above-noted components in support of computer-program product 1605. Exemplary operating systems include Windows® or the like from Microsoft® Corporation, Solaris® from Oracle®, LINUX, UNIX, and the like.

User input devices 1640 include all possible types of devices and mechanisms to input information to computer system 1602. These may include a keyboard, a keypad, a mouse, a scanner, a digital drawing pad, a touch screen incorporated into the display, audio input devices such as voice recognition systems, microphones, and other types of input devices. In various embodiments, user input devices 1640 are typically embodied as a computer mouse, a trackball, a track pad, a joystick, wireless remote, a drawing tablet, a voice command system. User input devices 1640 typically allow a user to select objects, icons, text and the like that appear on monitor 1606 via a command such as a click of a button or the like. User output devices 1630 include all possible types of devices and mechanisms to output information from computer 1602. These may include a display (e.g., monitor 1606), printers, non-visual displays such as audio output devices, etc.

Communications interface 1650 provides an interface to other communication networks 1695 and devices and may serve as an interface to receive data from and transmit data to other systems, WANs and/or Internet 1618. Embodiments of communications interface 1650 typically include an Ethernet card, a modem (telephone, satellite, cable, ISDN), a (asynchronous) digital subscriber line (DSL) unit, a FireWire® interface, a USB® interface, a wireless network adapter, and the like. For example without limitation, communications interface 1650 may be coupled to a computer network, to a FireWire® bus, or the like. In other embodiments, communications interface 1650 may be physically integrated on the motherboard of computer 1602, and/or may be a software program, or the like.

RAM 1670 and non-volatile storage drive 1680 are examples of tangible computer-readable media configured to store data such as computer-program product embodiments of the present invention, including executable computer code, human-readable code, or the like. Other types of tangible computer-readable media include floppy disks, removable hard disks, optical storage media such as CD-ROMs, DVDs, bar codes, semiconductor memories such as flash memories, read-only-memories (ROMs), battery-backed volatile memories, networked storage devices, and the like. RAM 1670 and non-volatile storage drive 1680 may be configured to store the basic programming and data constructs that provide the functionality of various embodiments of the present invention, as described above.

Software instruction sets that provide the functionality of the present invention may be stored in RAM 1670 and non-volatile storage drive 1680. These instruction sets or code may be executed by processor(s) 1660. RAM 1670 and non-volatile storage drive 1680 may also provide a repository to store data and data structures used in accordance with the present invention. RAM 1670 and non-volatile storage drive 1680 may include a number of memories including a main random access memory (RAM) to store of instructions and data during program execution and a read-only memory (ROM) in which fixed instructions are stored. RAM 1670 and non-volatile storage drive 1680 may include a file storage subsystem providing persistent (non-volatile) storage of program and/or data files. RAM 1670 and non-volatile storage drive 1680 may also include removable storage systems, such as removable flash memory.

Bus subsystem 1690 provides a mechanism to allow the various components and subsystems of computer 1602 communicate with each other as intended. Although bus subsystem 1690 is shown schematically as a single bus, alternative embodiments of the bus subsystem may utilize multiple busses or communication paths within computer 1602.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine-readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein, the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read-only memory (ROM), random access memory (RAM), magnetic RAM, core memory, magnetic disk storage mediums, optical storage mediums, flash memory devices and/or other machine-readable mediums for storing information. The term “machine-readable medium” includes, but is not limited to portable or fixed storage devices, optical storage devices, and/or various other storage mediums capable of storing that contain or carry instruction(s) and/or data.

While the principles of the disclosure have been described above in connection with specific apparatuses and methods, it is to be clearly understood that this description is made only by way of example and not as limitation on the scope of the disclosure.

What is claimed is:

1. A method comprising:
receiving automation instructions from a requesting party;
determining a site configuration of an automated laboratory in which to execute the instructions;
generating a transcript executable by the automated laboratory, based at least in part on the automation instructions and the site configuration;
scheduling execution of the transcript on automated laboratory equipment at the automated laboratory; and
receiving results based at least in part on the execution of the transcript on the automated laboratory equipment.

2. The method of claim 1 wherein the automation instructions include a program written in a generic language and wherein the program describes an experiment.

3. The method of claim 2 wherein generating the transcript includes translating the program into a set of operations to be performed for the experiment at the automated laboratory.

4. The method of claim 2 further comprising:
identifying a plurality of sites that are capable of performing the experiment; and
receiving a selection of a site from the plurality of sites and arranging transfer of one or more samples to the selected site, wherein the generated transcript includes a set of operations to be performed at the selected site.

5. The method of claim 1 wherein generating the transcript includes translating the automation instructions in a generic language to the transcript in site-specific instructions and wherein the transcript includes a set of operations to be executed at the automated laboratory based on the site configuration.

6. The method of claim 1 further comprising:
receiving additional automation instructions from another requesting party;
determining another site configuration of another automated laboratory in which to execute the additional instructions;
generating another transcript executable by the other automated laboratory, based at least in part on the additional instructions and the other site configuration; and
scheduling execution of the other transcript on a set of laboratory equipment at the other automated laboratory.

7. The method of claim 1 further comprising:
receiving additional automation instructions from another requesting party;
determining to execute the additional instructions at the automated laboratory;
generating another transcript executable by the automated laboratory, based at least in part on the additional instructions and the site configuration at the automated laboratory; and
scheduling execution of the other transcript on a set of automated laboratory equipment at the automated laboratory.

8. A method comprising:
receiving laboratory automation instructions in a first language from a requesting party;
determining a first target laboratory system in which to execute the instructions;
generating a first transcript executable by the first target laboratory system based at least in part on the first language;
determining a second target laboratory system in which to execute the instructions; and
generating a second transcript executable by the second target laboratory system, based at least in part on the first language.

9. The method of claim 8 wherein the second target laboratory system is a manual labor laboratory system, and wherein the second transcript is a set of natural language instructions.

10. The method of claim 8 wherein the first transcript is generated further based upon a site-specific configuration for the first target laboratory system.

11. The method of claim 8 wherein the first language is a high-level language.

12. The method of claim 8 wherein the first target laboratory system is an automated laboratory system.

13. The method of claim 8 further comprising:
generating an additional transcript executable by the first target laboratory system based at least in part on the first language, wherein the first target laboratory system is a semi-automated system that can perform both automated and manual tasks.

14. A method comprising:
receiving automation instructions from a requesting party in a first language;
determining a plurality of sites compatible with the automation instructions;
receiving a selection of a site from the plurality of sites in which to execute the instructions, the site being associated with an automated laboratory;
retrieving a site configuration of the site; and
generating a transcript executable by the automated laboratory in a second language, based at least in part on the automation instructions and the site configuration.

15. The method of claim 14 further comprising:
generating another transcript executable by the automated laboratory based at least in part on additional instructions in a third language and the site configuration; and
scheduling implementation of the transcript and the other transcript using the automated laboratory.

16. The method of claim 14 further comprising:
communicating with automation equipment based at least in part on the automation instructions to accomplish a set of operations specified by the transcript; and
reporting results of the transcript to the requesting party.

17. The method of claim 14 wherein generating the transcript includes translating the automation instructions to the transcript that includes a set of site-specific operations to be executed on the site.

18. The method of claim 14 further comprising:
determining an order, a timing, and parallelization of operations from the transcript based on one or more constraints; and
executing the operations from the transcript based on the determined order, timing, and parallelization of operations.

19. The method of claim 14 further comprising:
upon determining the plurality of sites compatible with the automation instructions, presenting the plurality of sites compatible with the automation instructions and cost information associated with each of the plurality of sites.

20. The method of claim 14 further comprising:
determining one or more solutions that meet one or more constraints associated with the automation instructions, the one or more solutions being associated with one or more sites, wherein generating the transcript includes translating the automation instructions into a set of operations that satisfy the site configuration and the one or more constraints associated with the automation instructions.
